(19) United States
(12) Patent Application Publication
(10) Pub. No.: US 2013/0291018 A1
(43) Pub. Date: Oct. 31, 2013

(54) CONNECTED MULTI-SCREEN DIGITAL PROGRAM GUIDE

(71) Applicant: MOBITV, INC., Emeryville, CA (US)

(72) Inventors: Allen Billings, Lafayette, CA (US); Kirsten Hunter, San Francisco, CA (US); Ray De Renzo, Walnut Creek, CA (US); Dan Gardner, New York, NY (US); Michael Treff, Brooklyn, NY (US); Christopher Hall, Brooklyn, NY (US); Tommy Kuntze, Oakland, CA (US); Jesse Wang, New York, NY (US)

(73) Assignee: MobiTV, Inc., Emeryville, CA (US)

(21) Appl. No.: 13/668,430

(22) Filed: Nov. 5, 2012

Related U.S. Application Data
(60) Provisional application No. 61/639,689, filed on Apr. 27, 2012.

(51) Int. Cl. H04N 21/45

(52) U.S. Cl. CPC H04N 21/4532
USPC 725/46

(57) ABSTRACT

Techniques and mechanisms are described herein for presenting a connected multi-screen digital program guide. According to various embodiments, a personalized content guide may be transmitted to a first client machine. The first client machine may be associated with a content management account. The personalized content guide may include a plurality of media content channels created based on media content viewing history information associated with the content management account. Each of the media content channels including a respective plurality of media content items available for presentation in association with the content management account. A message indicating a selection of one of the media content items may be received from the first client machine. An instruction for presenting the selected media content item may be transmitted to the second client machine.

### CROSS-REFERENCE TO RELATED APPLICATIONS

This application claims priority to Provisional U.S. Patent Application No. 61/639,689 by Billings et al., filed Apr. 27, 2012, titled “CONNECTED MULTI-SCREEN VIDEO”, which is hereby incorporated by reference in its entirety and for all purposes.

### TECHNICAL FIELD

The present disclosure relates to connected multi-screen digital program guides.

### DESCRIPTION OF RELATED ART

A variety of devices in different classes are capable of receiving and playing video content. These devices include tablets, smartphones, computer systems, game consoles, smart televisions, and other devices. The diversity of devices combined with the vast amounts of available media content has created a number of different presentation mechanisms.

However, mechanisms for providing common experiences across different device types and content types are limited. Consequently, the techniques of the present invention provide mechanisms that allow users to have improved experiences across devices and content types.

### BRIEF DESCRIPTION OF THE DRAWINGS

The disclosure may best be understood by reference to the following description taken in conjunction with the accompanying drawings, which illustrate particular embodiments.

FIGS. 1 and 2 illustrate examples of systems that can be used with various techniques and mechanisms of the present invention.

FIGS. 3-15 illustrate examples of user interfaces.

FIGS. 16-18 illustrate examples of techniques for communicating between various devices.

FIG. 19 illustrates one example of a user interface.

FIG. 20 illustrates one example of techniques for delivering a personalized content guide.

FIG. 21 illustrates one example of techniques for selecting personalized content.

FIGS. 22-23 illustrate examples of systems.

FIG. 24 illustrates examples of encoding streams.

FIG. 25 illustrates one example of an exchange used with a media delivery system.

FIG. 26 illustrates one technique for generating a media segment.

FIG. 27 illustrates one example of a system.

### DESCRIPTION OF EXAMPLE EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of fragments, particular servers and encoding mechanisms. However, it should be noted that the techniques of the present invention apply to a wide variety of different fragments, segments, servers and encoding mechanisms. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Overview

Disclosed herein are mechanisms and techniques that may be used to provide a connected, multi-screen digital program guide. Users may employ various types of devices to view media content such as video and audio. The devices may be used alone or together to present the media content. The media content may be received at the devices from various sources. According to various embodiments, different devices may communicate to present a common interface across the devices. The user interface may display a digital program guide. The digital program guide may be used to organize, select, sort, filter, and/or access content that is available from the various sources and that is available for presentation on the various devices. The digital program guide, which is also referred to herein as a personalized content guide, may be customized for a particular user or content management account based on factors such as viewing history and preference information associated with an account.

### EXAMPLE EMBODIMENTS

According to various embodiments, a connected multi-screen system may provide a common experience across devices while allowing multi-screen interactions and navigation. Content may be organized around content entities such as shows, episodes, sports categories, genres, etc. The system includes an integrated and personalized guide along with effective search and content discovery mechanisms. Co-watching and companion information is provided to allow for social interactivity and metadata exploration.

According to various embodiments, a connected multi-screen interface is provided to allow for a common experience across devices in a way that is optimized for various device strengths. Media content is organized around media entities such as shows, programs, episodes, characters, genres, categories, etc. In particular embodiments, live television, on-demand, and personalized programming are presented together. Multi-screen interactions and navigation are provided with social interactivity, metadata exploration, show information, and reviews.

According to various embodiments, a connected multi-screen interface may be provided on two or more display screens associated with different devices. The connected interface may provide a user experience that is focused on user behaviors, not on a particular device or service. In particular embodiments, a user may employ different devices for different media-related tasks. For instance, a user may employ a television to watch a movie while using a connected tablet computer to search for additional content or browse information related to the movie.

According to various embodiments, a connected personalized content guide may facilitate user interaction with content received from a variety of sources. For instance, a user may receive content via a cable or satellite television connection, an online video-on-demand provider such as Netflix, a digital video recorder (DVR), a video library stored on a network storage device, and an online media content store such as iTunes or Amazon. Instead of navigating and searching each of these content sources separately, a user may be presented with a digital content guide that combines content from the different sources. In this way, a user can search and navigate content based on the user's preferences without being bound to a particular content source, service, or device.

According to various embodiments, a personalized content guide may be used to present content in categories corresponding to user preferences. For instance, the content management system may collect data indicating that a particular user enjoys watching dramas. Then, the content management system may receive more detailed information indicating a preference for television dramas in particular. When a user accesses the personalized content guide, the user may be presented with channels reflecting these observed preferences. For instance, an electronic program guide may include a customized “Television Drama” channel that includes content that the user is estimated to enjoy.

According to various embodiments, an interface for displaying content in a guide format may be referred to herein as a digital or electronic guide, a content or program guide, a media guide, or some combination thereof. In particular embodiments, a personalized content guide may be displayed as part of a connected user interface in which different content playback and/or content management devices are linked. However, the devices need not always be linked in order to display the personalized content guide.

According to various embodiments, a connected personalized content guide may be used to present various types of information regarding relationships between content. For example, a personalized content guide may be used to present information regarding the next unwatched episode or movie in a series. As another example, a personalized content guide may be used to present information regarding content having similar subject matter, a common cast or crew member, or from a similar classification or genre.

According to various embodiments, a connected personalized content guide may be used to present various types of information regarding the accessibility of content. For example, when a content management account has access to a subscription-based media content provider such as Netflix, content available from the content provider may be included in the program guide. In this way, a user may be made aware of content already available on an on-demand basis. As another example, when content is available on a paid basis, such as via a content provider such as iTunes or Amazon, the content may be included within the program guide. In this way, a user may be made aware of content that the user does not yet have access to. As yet another example, when a content management account has access to content that is available at a particular time in the present or future, such as content available from a broadcast service, the content may be included within the program guide. In this way, a user may identify content that is subject to time-sensitive presentation. In particular embodiments, a user may be able to designated options specifying the types and sources of content to include in the program guide.

According to various embodiments, a connected personalized content guide may be used to organize media content that may be presented on different media content presentation devices. For example, a user may receive content via a cable television service subscription at a television. At the same time, the user may receive content via a Netflix service subscription at a computer. By combining this content into a single program guide, the user may be able to navigate, search, filter, and browse the content regardless of the device on which the content is presented. In particular embodiments, a personalized content guide may be customized based on the types of devices available for content presentation. For instance, a user may prefer to watch sports programming on a mobile phone while preferring to watch movies on a television. Depending on which of the two devices are active and/or linked with a connected user interface, different content and/or channels may be presented in the connected personalized content guide.

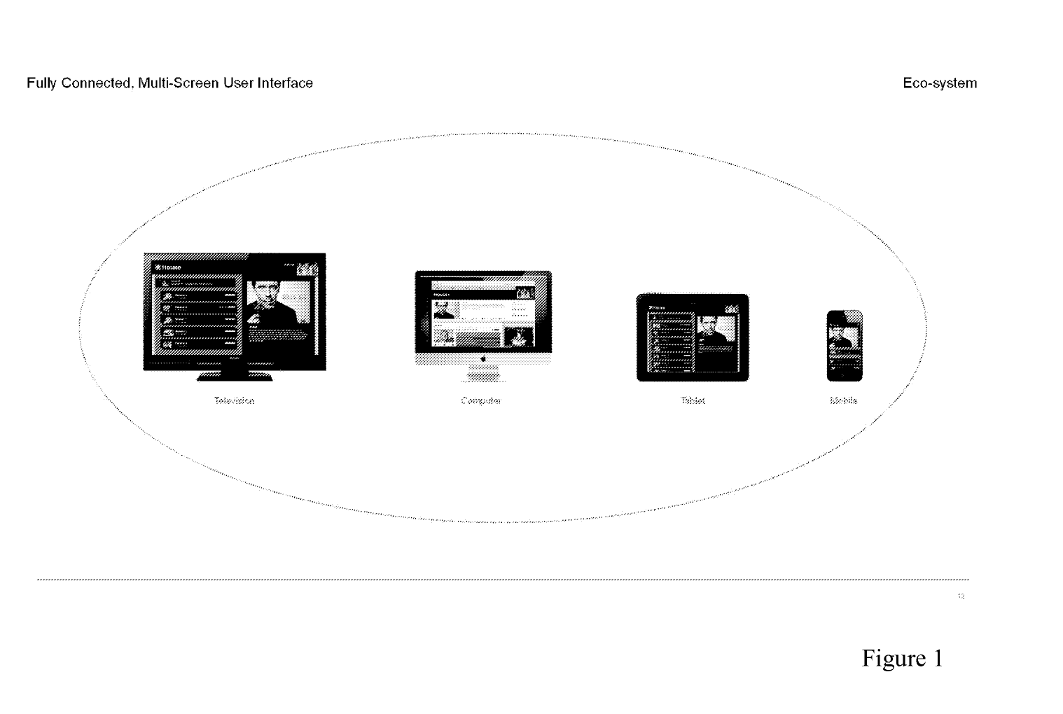

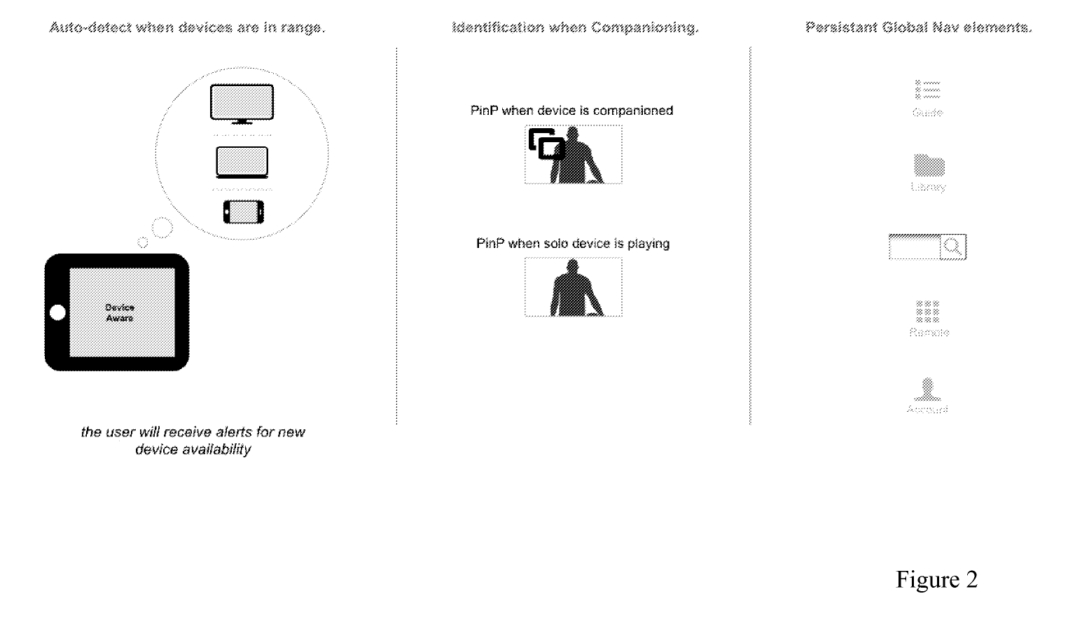

FIGS. 1 and 2 illustrate examples of systems that can be used with various techniques and mechanisms of the present invention. As shown in FIG. 1, various devices may be used to view a user interface for presenting and/or interacting with content. According to various embodiments, one or more conventional televisions, smart televisions, desktop computers, laptop computers, tablet computers, or mobile devices such as smart phones may be used to view a content-related user interface.

According to various embodiments, a user interface for presenting and/or interacting with media content may include various types of components. For instance, a user interface may include one or more media content display portions, user interface navigation portions, media content guide portions, related media content portions, media content overlay portions, web content portions, interactive application portions, or social media portions.

According to various embodiments, the media content displayed on the different devices may be of various types and/or derive from various sources. For example, media content may be received from a local storage location, a network storage location, a cable or satellite television provider, an Internet content provider, or any other source. The media content may include audio and/or video and may be television, movies, music, online videos, social media content, or any other content capable of being accessed via a digital device.

As shown in FIG. 2, devices may communicate with each other. According to various embodiments, devices may communicate directly or through another device such as a network gateway or a remote server. In some instances, communications may be initiated automatically. For example, an active device that comes within range of another device that may be used in conjunction with techniques described herein may provide an alert message or other indication of the possibility of a new connection. As another example, an active device may automatically connect with a new device within range.

According to various embodiments, a user interface may include one or more portions that are positioned on top of another portion of the user interface. Such a portion may be referred to herein as a picture in picture, a PinP, an overlaid portion, an asset overlay, or an overlay.

According to various embodiments, a user interface may include one or more navigation elements, which may include, but are not limited to: a media content guide element, a library element, a search element, a remote control element, and an account access element. These elements may be used to access various features associated with the user interface, such as a search feature or media content guide feature.

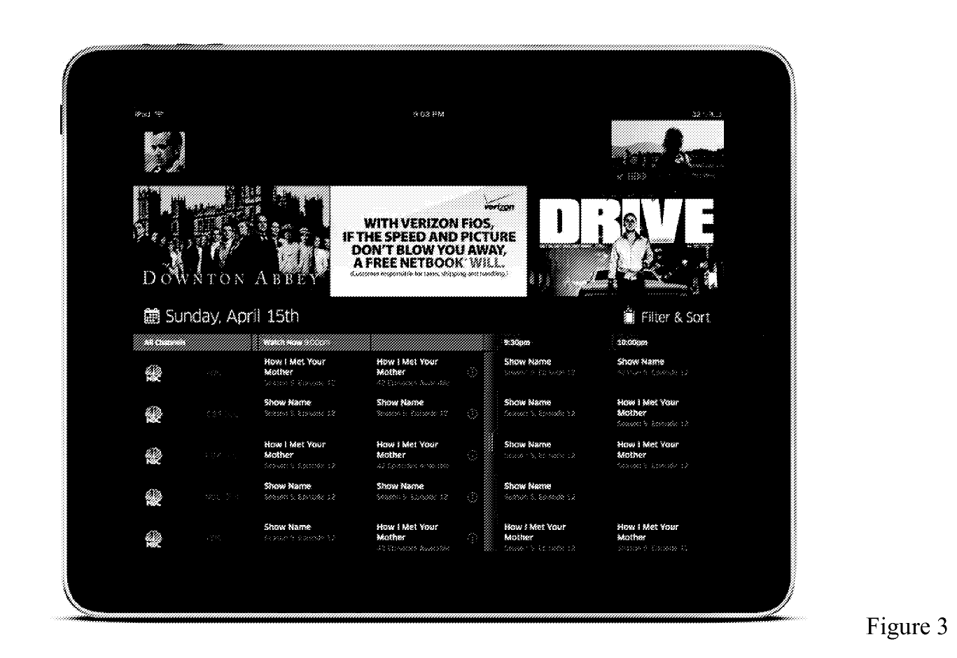

FIGS. 3-15 illustrate images of examples of user interfaces. According to various embodiments, the user interfaces shown may be presented on any of various devices. In some cases, user interfaces may appear somewhat differently on different devices. For example, different devices may have different screen display resolutions, screen display aspect ratios, and user input device capabilities. Accordingly, a user interface may be adapted to a particular type of device.

FIG. 3 illustrates an image of an example of a program guide user interface. According to various embodiments, a program guide user interface may be used to identify media content items for presentation. The program guide may include information such as a content title, a content source, a presentation time, an example video feed, and other information for each media content item. The program guide may also include other information, such as advertisements and filtering and sorting elements.

According to various embodiments, the techniques and mechanisms described herein may be used in conjunction with grid-based electronic program guides. In many grid-based electronic program guides, content is organized into “channels” that appear on one dimension of the grid and time that appears on the other dimension of the grid. In this way, the user can identify the content presented on each channel during a range of time.

According to various embodiments, the techniques and mechanisms described herein may be used in conjunction with mosaic programming guides. In mosaic programming guides, a display includes panels of actual live feeds as a channel itself. A user can rapidly view many options at the same time. Using the live channel as a background, a lightweight menu-driven navigation system can be used to position an overlay indicator to select video content. Alternatively, numeric or text based navigation schemes could also be used. Providing a mosaic of channels in a single channel instead of merging multiple live feeds into a single display decreases complexity of a device application. Merging multiple live feeds require individual, per channel feeds of content to be delivered and processed at an end user device. Bandwidth and resource usage for delivery and processing of multiple feeds can be substantial. Less bandwidth is used for a single mosaic channel, as a mosaic channel would simply require a video feed from a single channel. The single channel could be generated by content providers, service providers, etc.

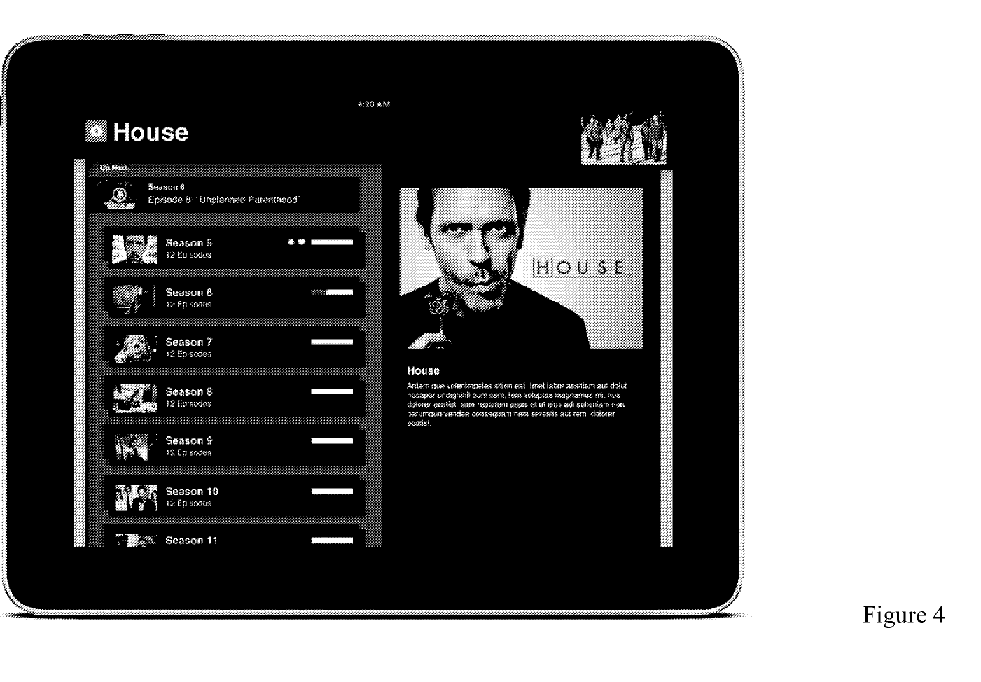

FIG. 4 illustrates an image of an example of a user interface for accessing media content items. According to various embodiments, a media content item may be a media content entity or a media content asset. A media content asset may be any discrete item of media content capable of being presented on a device. A media content entity may be any category, classification, container, or other data object capable of containing one or more media content assets or other media content entities. For instance, in FIG. 4, the television show “House” is a media content entity, while an individual episode of the television show “House” is a media content asset.

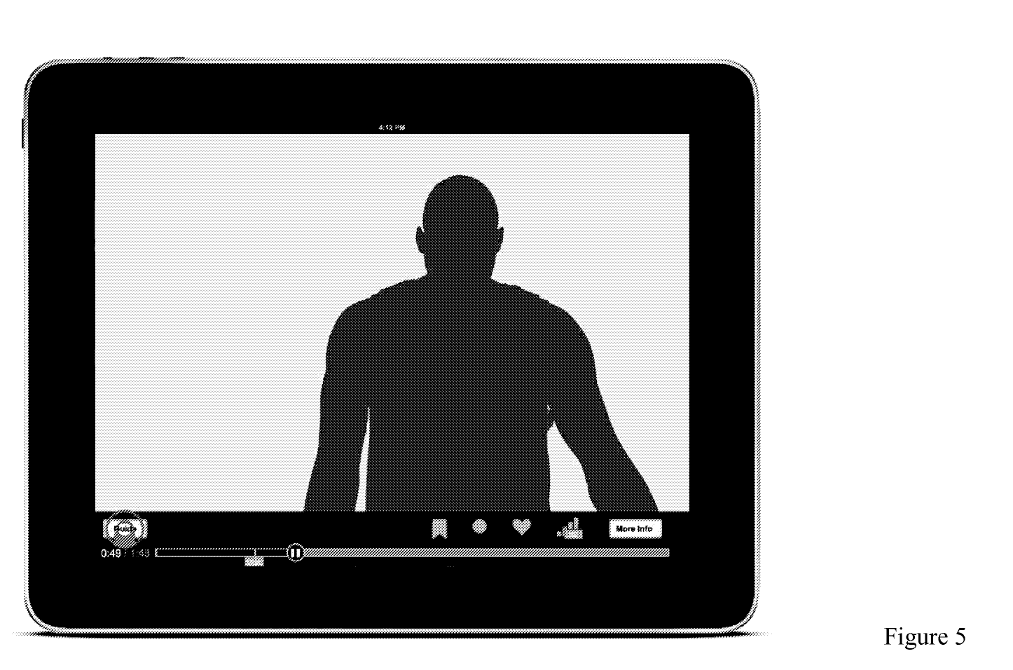

FIG. 5 illustrates an image of an example of a media content playback user interface. According to various embodiments, a media content playback user interface may facilitate the presentation of a media content item. The media content playback user interface may include features such as one or more media content playback controls, media content display areas, and media content playback information portions.

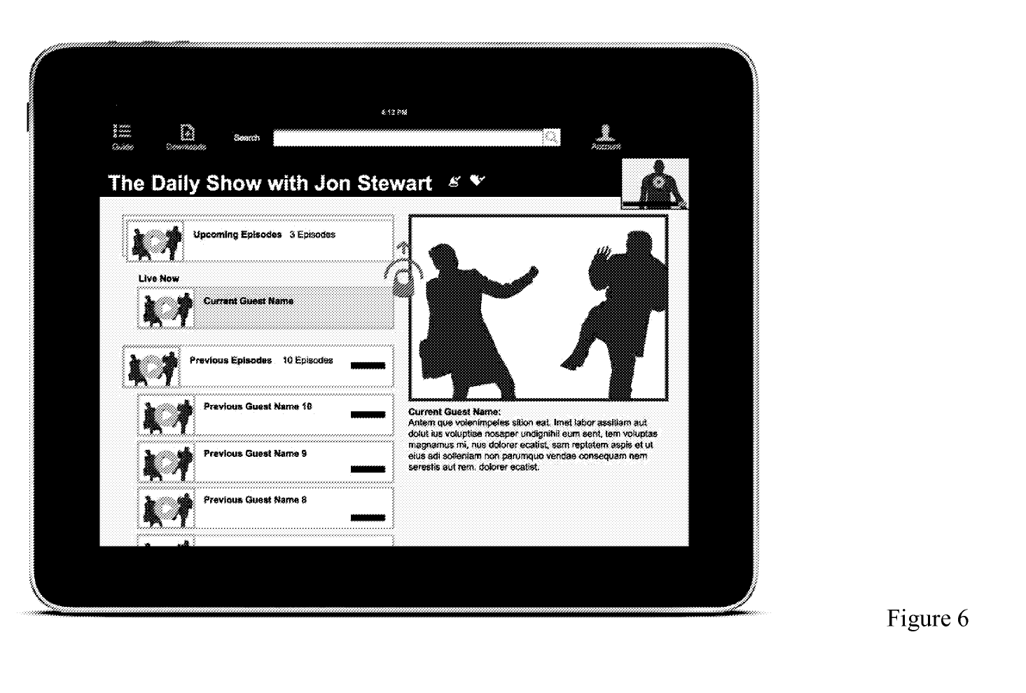

FIG. 6 illustrates an example of a global navigation user interface. According to various embodiments, the global navigation user interface may be used to display information related to a media content item. For instance, the example shown in FIG. 6 includes information related to the media content entity “The Daily Show with Jon Stewart.” In this case, the related information includes links or descriptions of previous and upcoming episodes as well as previous, current, and upcoming guest names. However, a global navigation user guide may display various types of related information, such as cast member biographies, related content, and content ratings. As with many other user interfaces described herein, the global navigation user guide may include an asset overlay for presenting a media clip, which in the example shown in FIG. 6 is displayed in the upper right corner of the display screen. The asset overlay may display content such as a currently playing video feed, which may also be presented on another device such as a television.

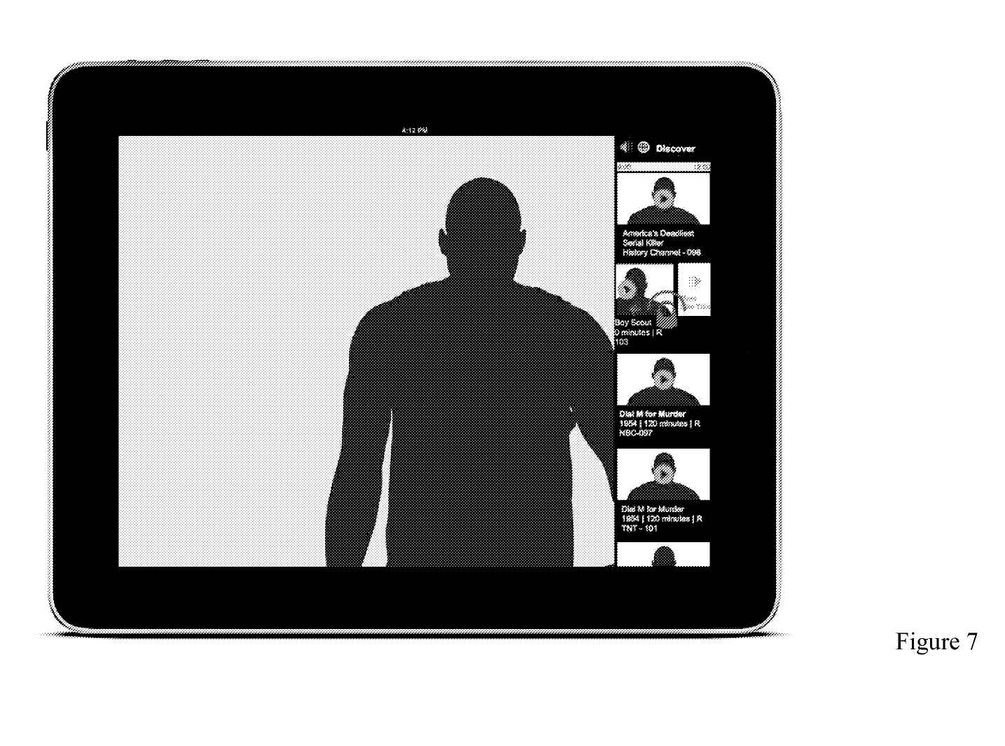

FIG. 7 illustrates an example of a discovery panel user interface within an overlay that appears in front of a currently playing video. According to various embodiments, the discovery panel user interface may include suggestions for other content. For instance, the discovery panel user interface may include information regarding content suggested based on an assumed preference for the content currently being presented. If a television program is being shown, the discovery panel may include information such as movies or other television programs directed to similar topics, movies or television programs that share cast members with the television program being shown, and movies or television programs that often reflect similar preferences to the television program being shown.

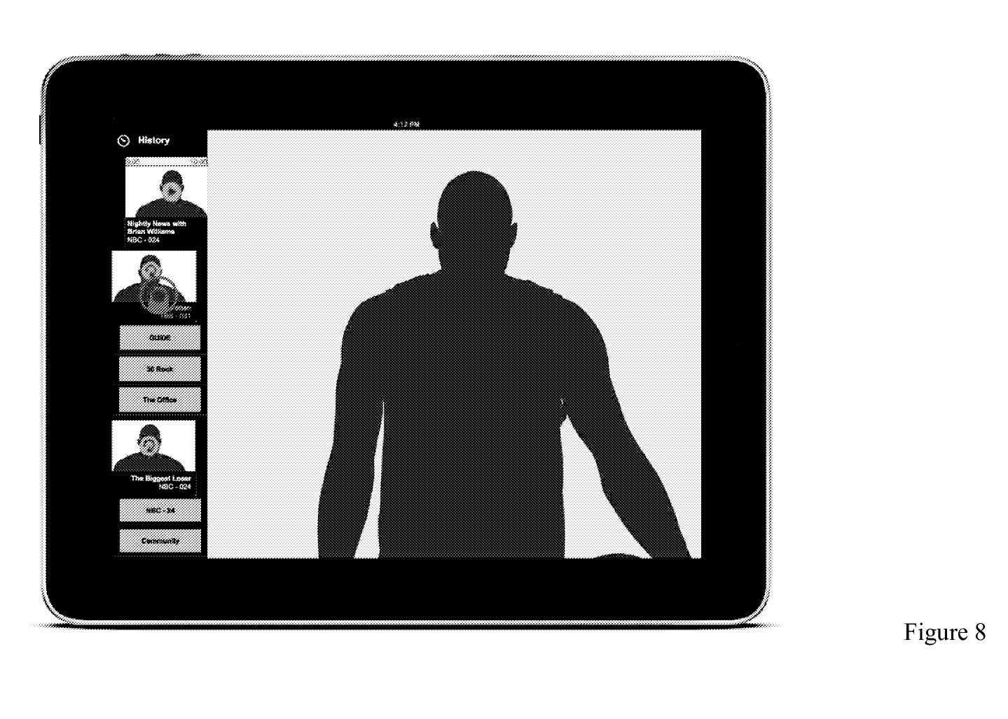

FIG. 8 illustrates an example of a history panel user interface within an overlay that appears in front of a currently playing video. According to various embodiments, the history panel user interface may include information regarding media content items that have been presented in the past. The history panel user interface may display various information regarding such media content items, such as thumbnail images, titles, descriptions, or categories for recently viewed content items.

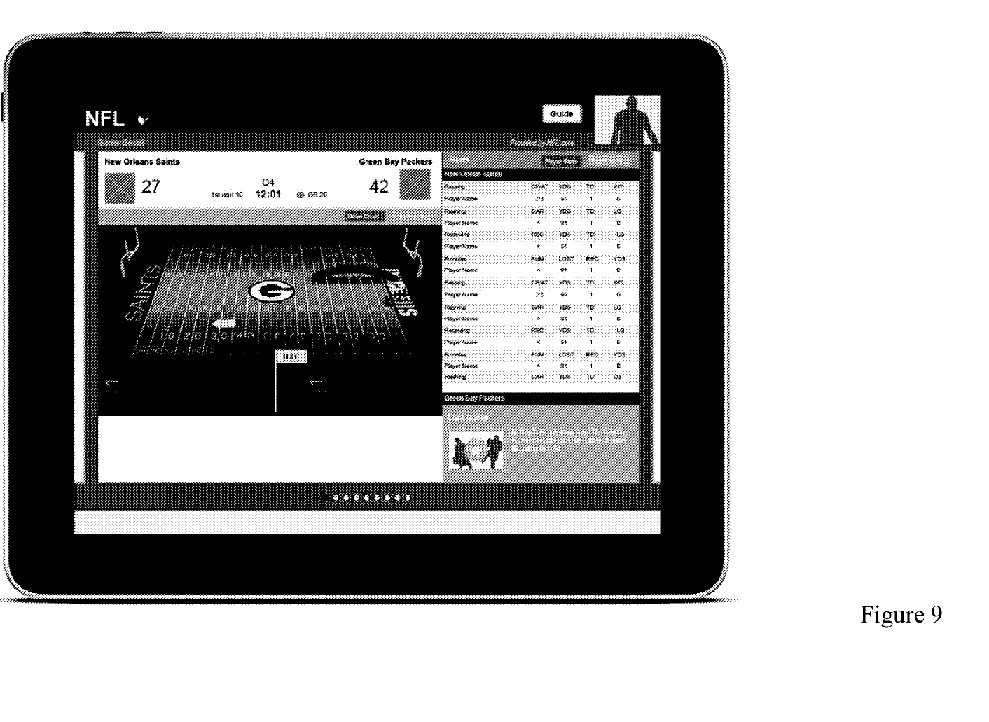

FIG. 9 illustrates an example of an asset overlay user interface configured for companion or co-watching. According to various embodiments, an asset overlay user interface may display information related to content being presented. For example, a user may be watching a football game on a television. At the same time, the user may be viewing related information on a tablet computer such as statistics regarding the players, the score of the game, the time remaining in the game, and the teams' game playing schedules. The asset overlay user interface that presents a smaller scale version of the content being presented on the other device.

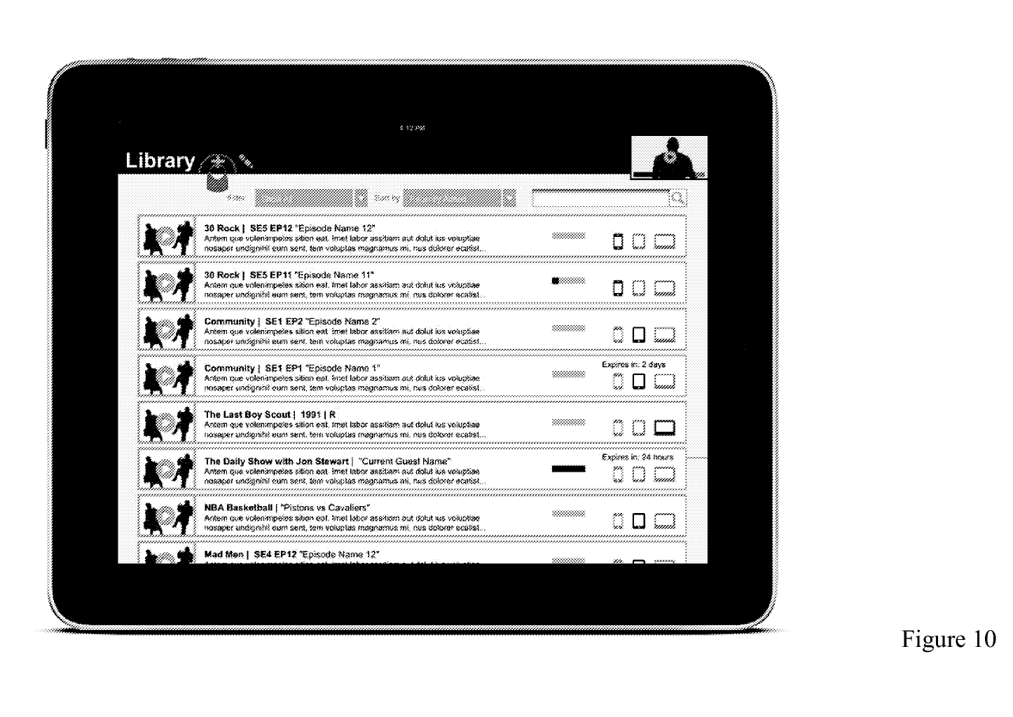

FIG. 10 illustrates an image of an example of a library user interface. According to various embodiments, the library user interface may be used to browse media content items purchased, downloaded, stored, flagged, or otherwise acquired for playback in association with a content management account. The library user interface may include features such as one or more media content item lists, media content item list navigation elements, media content item filtering, sorting, or searching elements. The library user interface may display information such as a description, categorization, or association for each media content item. The library user interface may also indicate a device on which the media content item is stored or may be accessed.

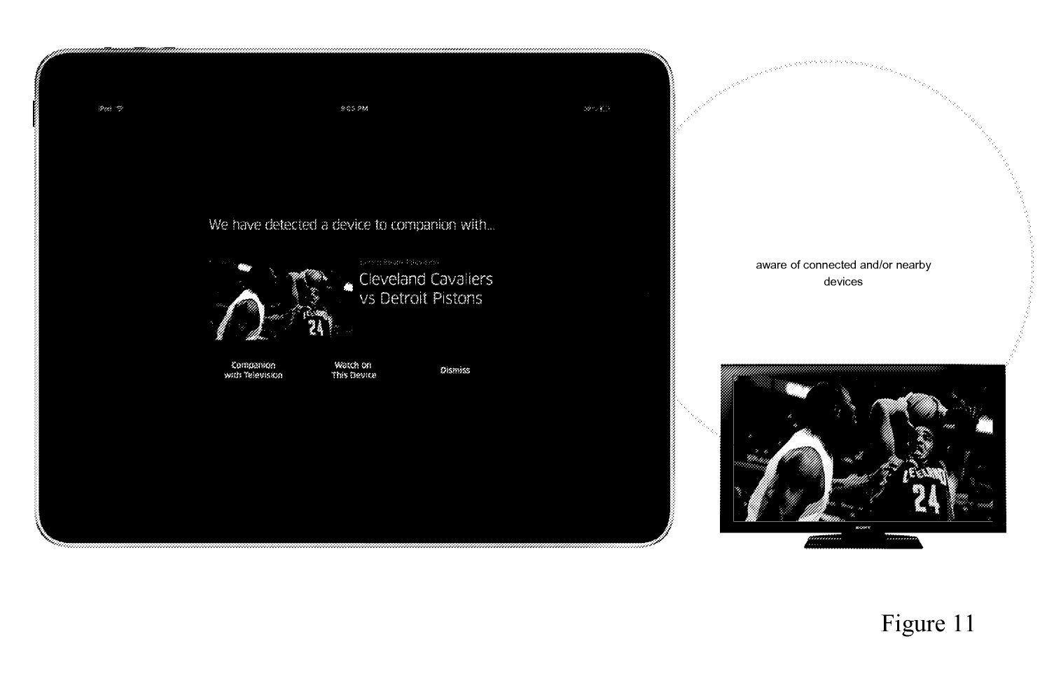

FIGS. 11-15 illustrate images of examples of a connected user interface displayed across two devices. In FIG. 11, a sports program is presented on a television while a content guide is displayed on a tablet computer. Because the television is capable of connecting with the tablet computer, the tablet computer presents an alert message that informs the user of the possibility of connecting. Further, the alert message allows the user to select an option such as watching the television program on the tablet computer, companioning with the television to view related information on the tablet computer, or dismissing the connection.

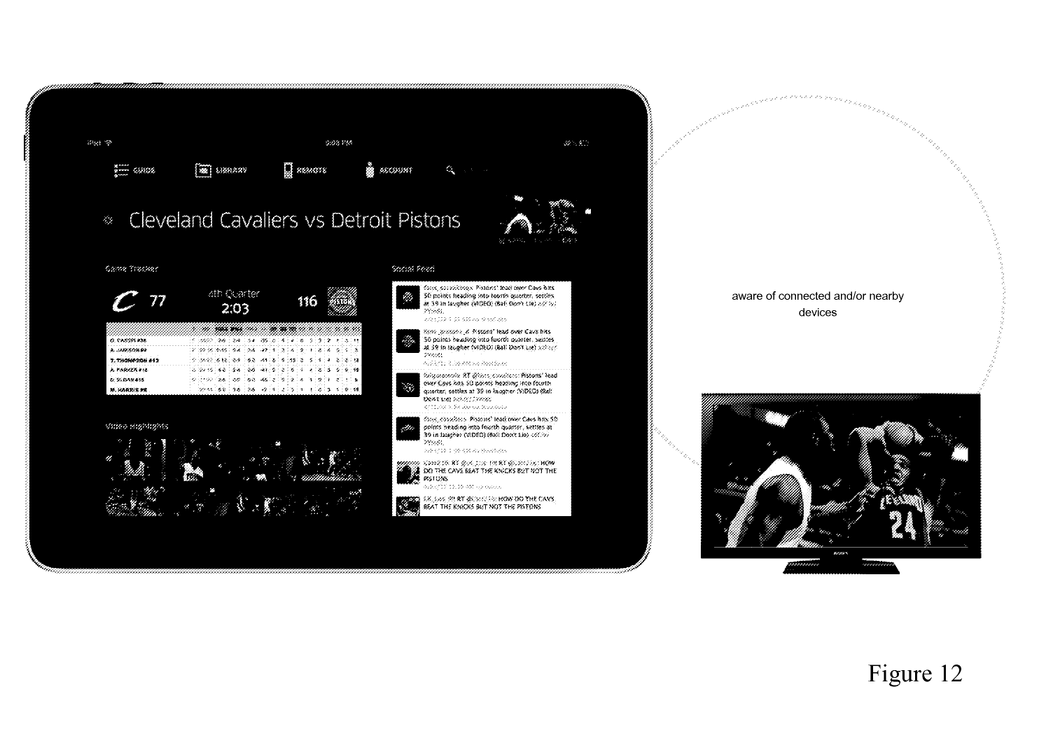

In FIG. 12, the tablet computer is configured for companion viewing. In companion viewing mode, the tablet computer may display information related to the content displayed on the television. For instance, in FIG. 12, the tablet computer is displaying the score of the basketball game, social media commentary related to the basketball game, video highlights from the game, and play statistics. In addition, the tablet computer displays a smaller, thumbnail image sized video of the content displayed on the television.

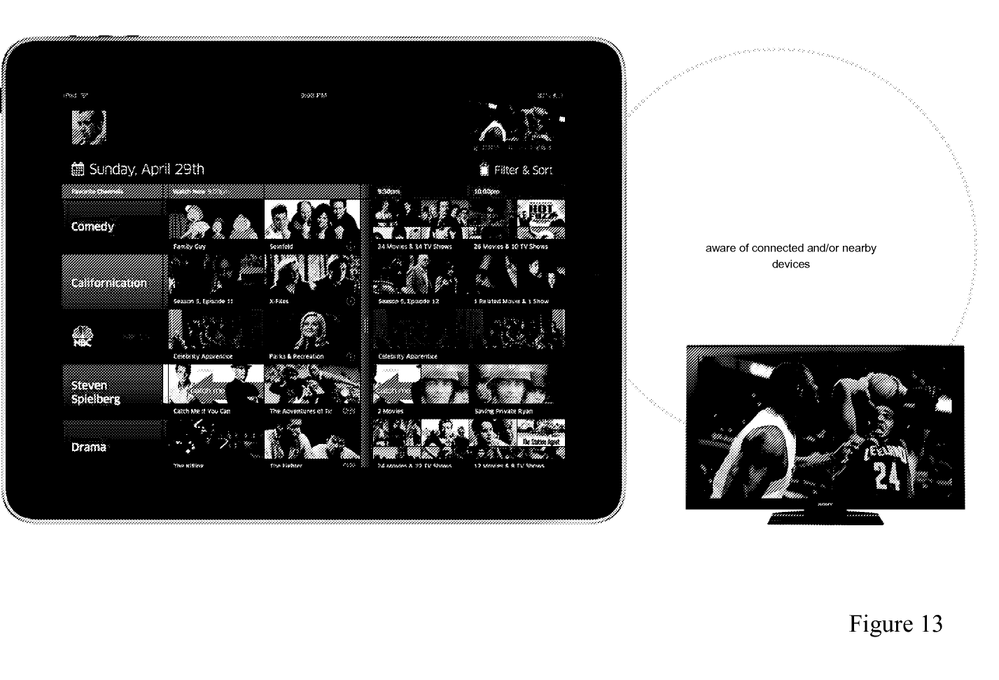

In FIG. 13, the user browses for new content while continuing to view the basketball game in companion mode across the two devices. Accordingly, the tablet computer displays a content guide for selecting other content while continuing to display the smaller, thumbnail image sized video of the basketball game displayed on the television.

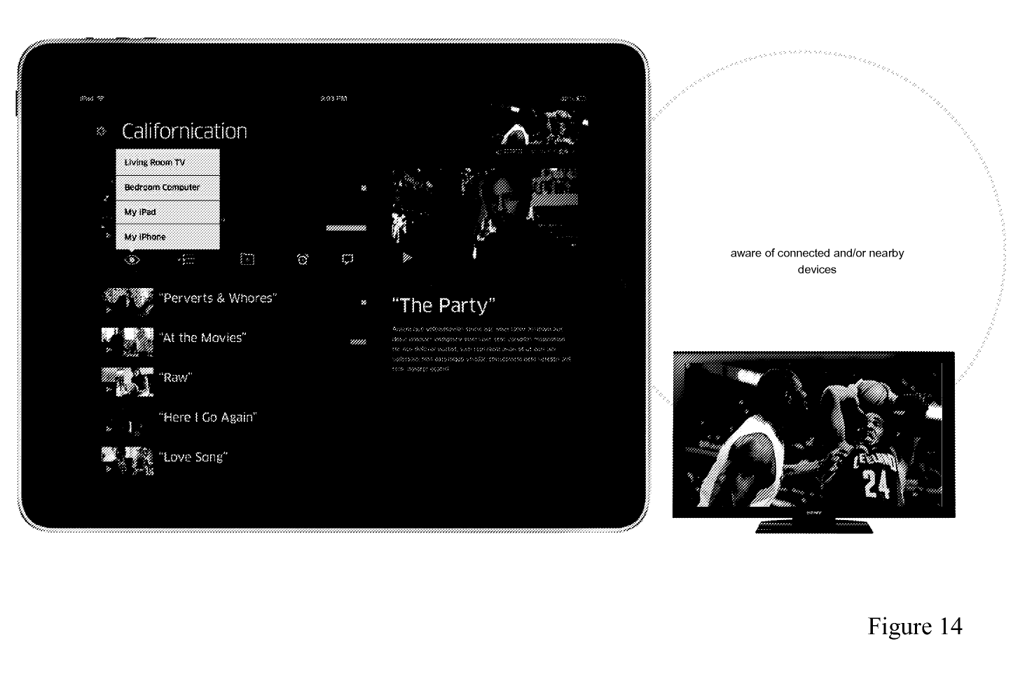

In FIG. 14, the user is in the process of selecting a new media content item for display. Here the new media content item is a television episode called “The Party.”After selecting the media content item, the user may select a device for presenting the content. In FIG. 14, the available devices for selection include the Living Room TV, the Bedroom Computer, My iPad, and My iPhone. By allowing control of content across different devices, the connected user interface can provide a seamless media viewing experience.

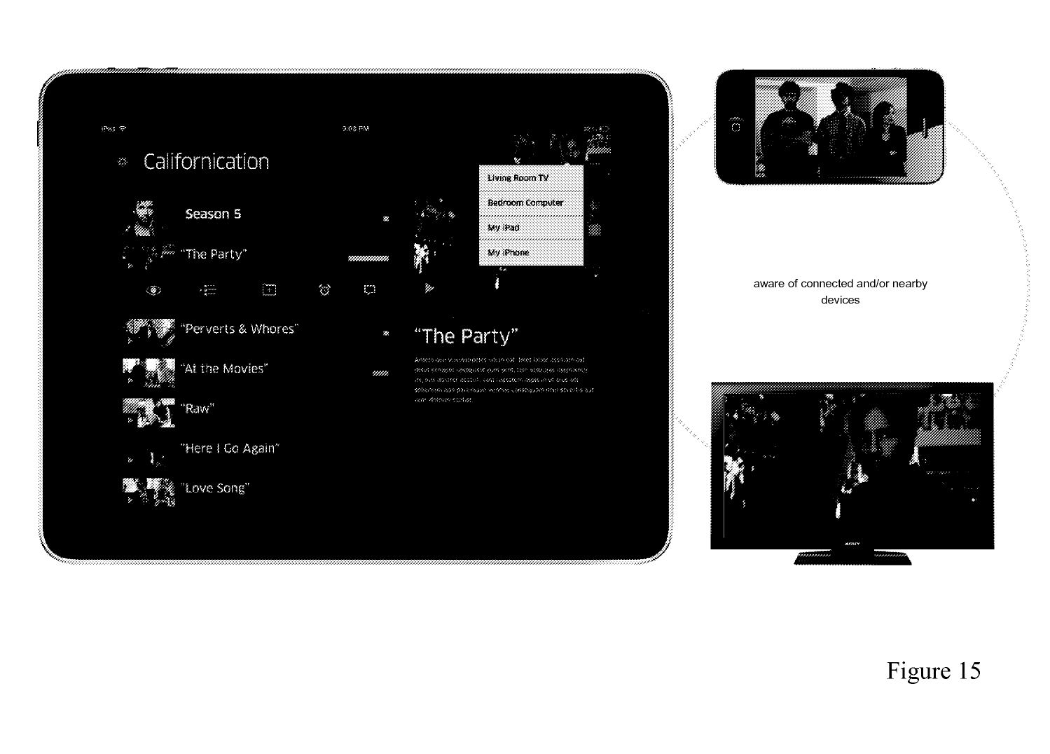

In FIG. 15, the user has selected to view the new television program on the Living Room TV. Additionally, a new device, which is a mobile phone, has entered the set of connected and/or nearby devices. By selecting the device within the user interface, the user can cause the currently playing video to also display on the mobile phone. In this way, the user can continue a video experience without interruption even if the user moves to a different physical location. For example, a user may be watching a television program on a television while viewing related information on a tablet computer. When the user wishes to leave the house, the user may cause the television program to also display on a mobile phone, which allows the user to continue viewing the program.

It should be noted that the user interfaces shown in FIGS. 3-15 are only examples of user interfaces that may be presented in accordance with techniques and mechanisms described herein. According to various embodiments, user interfaces may not include all elements shown in FIGS. 3-15 or may include other elements not shown in FIGS. 3-15. By the same token, the elements of a user interface may be arranged differently than shown in FIGS. 3-15. Additionally, user interfaces may be used to present other types of content, such as music, and may be used in conjunction with other types of devices, such as personal or laptop computers.

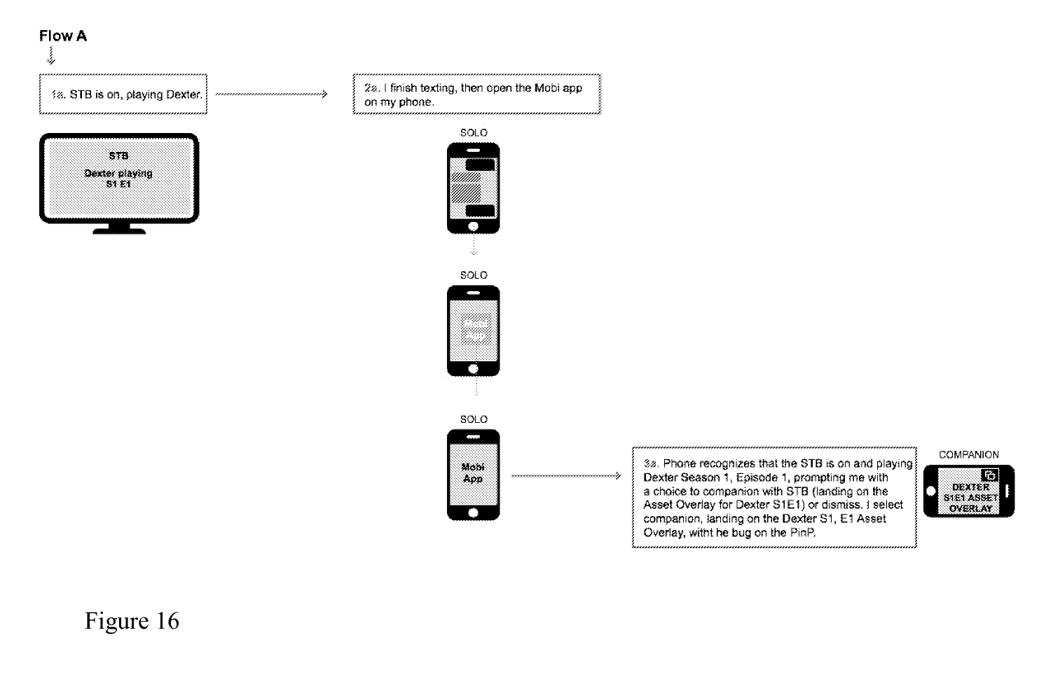

FIGS. 16-18 illustrate examples of techniques for communicating between various devices. In FIG. 16, a mobile device enters companion mode in communication with a television. According to various embodiments, companion mode may be used to establish a connected user interface across different devices. The connected user interface may allow a user to control presentation of media content from different devices, to view content across different devices, to retrieve content from different devices, and to access information or applications related to the presentation of content.

At operation 1a, an episode of the television show “Dexter” is playing on a television, which may also be referred to as a set top box (STB). According to various embodiments, the television show may be presented via any of various techniques. For instance, the television show may be received via a cable television network connection, retrieved from a storage location such as a DVR, or streamed over the Internet from a service provider such as Netflix.

According to various embodiments, the television or an associated device such as a cable box may be capable of communicating information to another device. For example, the television or cable box may be capable of communicating with a server via a network such as the Internet, with a computing device via a local network gateway, or with a computing device directly such as via a wireless network connection. The television or cable box may communicate information such as a current device status, the identity of a media content item being presented on the device, and a content management account associated with the device.

At operation 2a, a communication application is activated on a mobile device that is not already operating in companion mode. The communication application may allow the mobile device to establish a communication session for the purpose of entering into a companion mode with other media devices. When in companion mode, the devices may present a connected user interface for cross-device media display. In the example shown in FIG. 16, the communication application is a mobile phone application provided by MobiTV.

At operation 3a, the mobile phone receives a message indicating that the television is active and is playing the episode of the television show “Dexter.” Then, the mobile phone presents a message that provides a choice as to whether to enter companion mode or to dismiss the connection. When the user selects companion mode, the mobile phone initiates the communications necessary for presenting the connected display. For example, the mobile phone may transmit a request to a server to receive the information to display in the connected display.

In particular embodiments, the connected display may present an asset overlay for the content being viewed. For example, the asset overlay may display information related to the viewed content, such as other episodes of the same television program, biographies of the cast members, and similar movies or television shows. In asset overlay user interface may include a screen portion for displaying a small, thumbnail image sized video of the content being presented on the television. Then, the user can continue to watch the television program even while looking at the mobile phone.

In particular embodiments, a device may transmit identification information such as a content management account identifier. In this way, a server may be able to determine how to pair different devices when more than one connection is possible. When a device is associated with a content management account, the device may display information specific to the content management account such as suggested content determined based on the user's preferences.

In some embodiments, a device may automatically enter companion mode when an available connection is located. For instance, a device may be configured in an “auto-companion” mode. When a first device is in auto-companion mode, opening a second device in proximity to the first device causes the first device to automatically enter companion mode, for instance on the asset overlay page. Dismissing an alert message indicating the possibility of entering companion mode may result in the mobile phone returning to a previous place in the interface or in another location, such as a landing experience for a time-lapsed user. In either case, the television program being viewed on the television may be added to the history panel of the communication application.

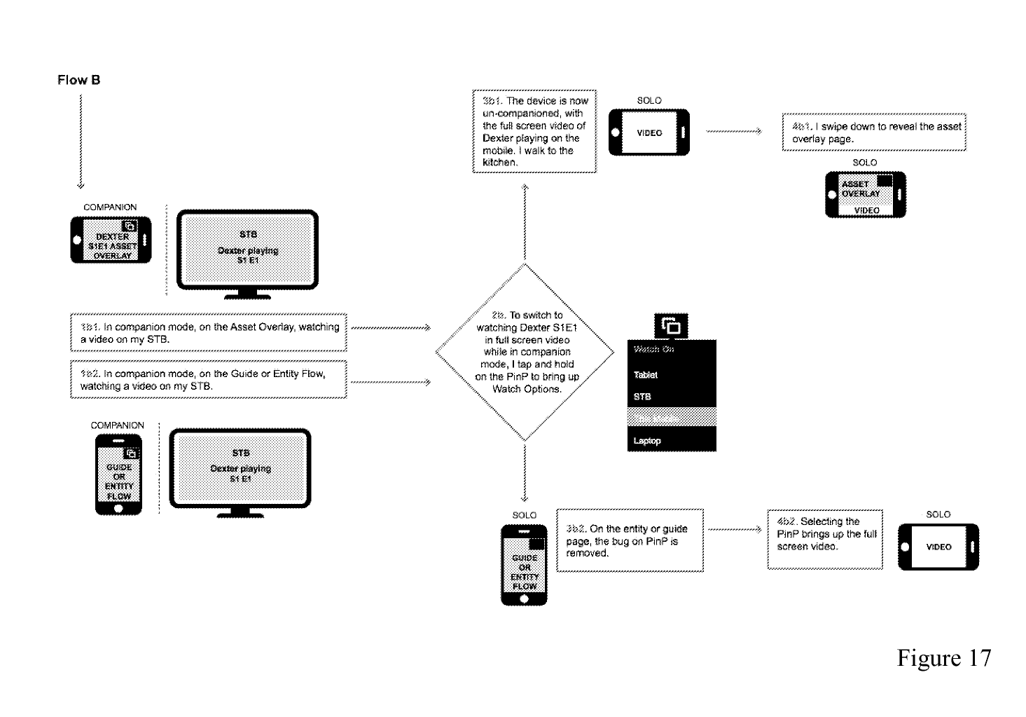

In FIG. 17, techniques are illustrated for displaying a video in full screen mode on a mobile device while the mobile device is in companion mode. Initially, the television is displaying an episode of the “Dexter” television show. At the same time, the mobile device is operating in companion mode. When the video is displayed in full screen mode, the user can, for instance, take the mobile device to a different location while continuing to view the video.

At operation 1b1, the mobile device is displaying an asset overlay associated with the television program as discussed with respect to FIG. 12. At operation 2b1, the mobile device is displaying an electronic program guide or an entity flow as discussed with respect to FIGS. 13-15. In both operations, the mobile device is also displaying a small, picture-in-picture version of the television show displayed on the television screen.

At operation 2b, the user would like to switch to watching the television program in full screen video on the mobile device while remaining in companion mode. In order to accomplish this task, the user activates a user interface element, for instance by tapping and holding on the picture-in-picture portion of the display screen. When the user activates the selection interface, the mobile device displays a list of devices for presenting the content. At this point, the user selects the mobile device that the user is operating.

At operation 3b1, the device is removed from companion mode. When companion mode is halted, the video playing on the television may now be presented in the mobile device in full screen. According to various embodiments, the device may be removed from proximity of the television while continuing to play the video.

At operation 4b1, the user selects the asset overlay for display on top of, or in addition to, the video. According to various embodiments, various user interface elements may be used to select the asset overlay for display. For example, the user may swipe the touch screen display at the mobile device. As another example, the user may click on a button or press a button on a keyboard.

At operation 3b2, the electronic program guide or entity flow continues to be displayed on the mobile device. At the same time, the “bug” is removed on the picture-in-picture portion of the display screen. As used herein, the term “bug” refers to an icon or other visual depiction. In FIG. 17, the bug indicates that the mobile device is operating in companion mode. Accordingly, the removal of the bug indicates that the device is no longer in companion mode.

At operation 4b2, the video is displayed in full screen mode. According to various embodiments, the video may be displayed in full screen mode by selecting the picture-in-picture interface. Alternately, the video may be automatically displayed in full screen mode when the device is no longer operating in companion mode.

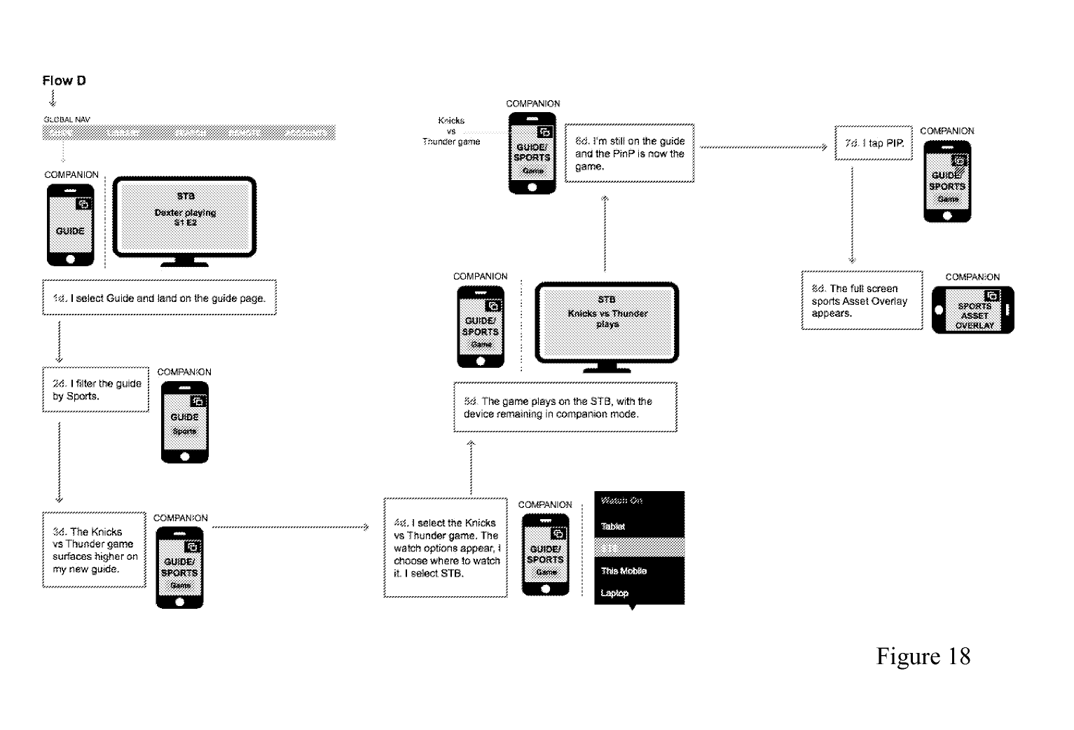

FIG. 18, techniques are illustrated for presenting an electronic program guide in a connected user interface. Initially, an episode of the television program Dexter is presented on a television. At the same time, a connected user interface is presented on a mobile phone configured in companion mode. As shown in operation 1d, the connected user interface displays a personalized content guide when the guide navigation element is selected.

At operation 2d, user input is received at the mobile phone. The user input includes a request to filter the personalized content guide to focus on sports. For instance, the user input may involve the selection of a “Sports” button displayed in the personalized content guide or the typing of a term such as “Sports” into a search mechanism.

According to various embodiments, when the user input is received, the personalized content guide is updated to display sports-related content. For example, the personalized content guide may display information such as sporting events available for viewing in the future via a broadcast network such as a cable or satellite television network. As another example, the personalized content guide may display information such as customized channels of sports-related content created based on preferences or viewing history associated with the content management account. As yet another example, the personalized content guide may display information such as sports-related programming that may be purchased or accessed on an on-demand basis, such as content available via a service such as Netflix or iTunes.

At operation 3d, a particular sporting event, a basketball game between the Knicks and the Thunder, is emphasized in the sports-focused personalized content guide. According to various embodiments, emphasizing a sporting event may involve displaying it at a higher or earlier level of the personalized content guide, highlighting or otherwise accentuating the visual presentation of the sporting event within the personalized content guide, or enlarging the visual presentation of the sporting event within the personalized content guide.

According to various embodiments, the basketball game may be emphasized based on viewing history or preference information associated with the content management account. For example, the user may have previously viewed more basketball games than games of other sports. As another example, the user may have expressly indicated a preference for basketball or for one or both of the Knicks and Thunder basketball teams. As yet another example, the user may have often clicked on or investigated basketball games in general and/or games involving the Knicks and/or Thunder teams specifically. Based on such information, the media system may estimate that the user is likely to enjoy watching the Knicks vs. Thunder basketball game.

At operation 4d, user input is received at the mobile device. The user input corresponds to a selection of the Knicks vs. Thunder basketball game. When the game is selected, the connected user interface presents a device selection interface for selecting a device for presenting the basketball game. The selection interface allows the user to choose between a tablet computer, a set top box (i.e. a television), the mobile phone, and a laptop computer for presenting the basketball game. In particular embodiments, these devices may have previously been associated or linked with the content management account. When this interface is presented, the user selects the television for presenting the basketball game.

At operation 5d, the selected sporting event is presented on the television screen. At the same time, the mobile device remains in companion mode. While in companion mode, the mobile device continues to present the connected user interface that displays the sports-focused personalized content guide.

At operation 6d, the connected user interface presented at the mobile phone is updated to present the selected sporting event in a picture-in-picture portion of the display screen. At the same time, the sports-focused personalized content guide continues to be display on another portion of the display screen, and the mobile phone remains in companion mode.

At operation 7d, user input is received at the mobile phone that is displaying the connected user interface. The user input corresponds to a selection of a picture-in-picture navigation element. For instance, the user may click or tap the portion of the screen corresponding to the picture-in-picture portion of the display screen.

At operation 8d, the connected user interface at the mobile phone is updated to display an asset overlay corresponding to the sporting event presented on the television. For example, the asset overlay may display information such as details regarding the teams, team members, or coaches involved in the sporting event. As another example, the asset overlay may display information such as scheduling details for other, related sporting events.

According to various embodiments, the asset overlay may replace the sports-focused personalized content guide previously displayed on the connected user interface at the mobile phone. At the same time, the picture-in-picture portion of the connected user interface may continue to display a smaller scale version of the sporting event.

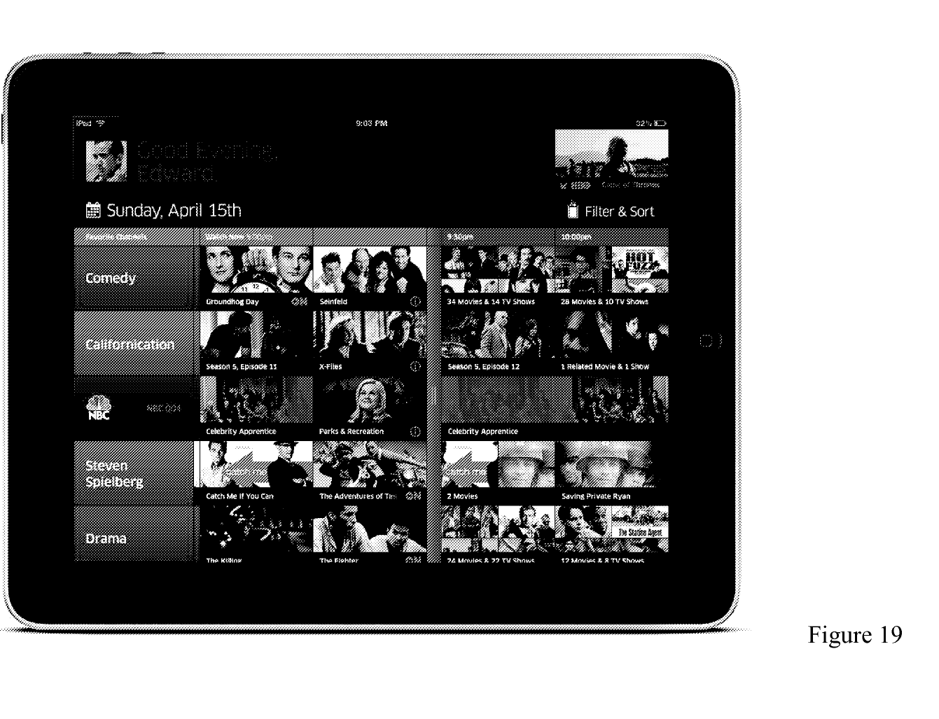

FIG. 19 illustrates an example of a personalized content guide. The personalized content guide shown in FIG. 19 is presented in a connected user interface displayed on a tablet computer. According to various embodiments, the personalized content guide may be presented on any of various devices, such as a television, a laptop computer, a tablet computer, a desktop computer, or a mobile phone. The personalized content guide may be used to select content for presentation on the tablet computer shown in FIG. 19 or on another, connected device.

According to various embodiments, a connected personalized content guide may be provided in association with a particular content management account. For instance, in FIG. 19, the connected personalized content guide is provided in association with a content management account in which the user's first name is Edward. By providing a connected personalized content guide for a particular content management account, the personalized content guide can be customized in accordance with user preferences and choices.

According to various embodiments, a connected personalized content guide may present a variety of content channels for organizing content. In the example illustrated in FIG. 19, these channels include “Comedy,” “Californication,” “NBC,” “Stephen Spielberg,” and “Drama.” However, in other examples, other channels may be present. In particular embodiments, the user interface may be scrolled or otherwise operated to display additional and/or different channels.

According to various embodiments, a content channel presented in a connected personalized content guide may include content drawn from a variety of sources. That is, in contrast to a traditional television channel that includes broadcast television content, a channel in a connected personalized content guide may include content such as on-demand video available from a digital subscription-based content source such as Netflix, content available to be purchase from a digital content store such as iTunes, and content available on a broadcast basis such as television content.

According to various embodiments, a content channel presented in a connected personalized content guide may include content available at or near the time at which the personalized content guide is displayed. For instance, in the example shown in FIG. 19, the personalized content guide includes a variety of content available at 9:00 pm, which is approximately when the guide is presented. The content available at the present time may include content that is currently available via a broadcast network, such as cable or satellite television. Alternately, or additionally, the content available at the present time may include content that is available on demand from a service such as Netflix or iTunes.

According to various embodiments, a content channel presented in a connected personalized content guide may include content available in the future. For instance, in the example shown in FIG. 19, the personalized content guide includes content within each channel available at 9:30 pm and 10:00 pm. The content available in the future may be, for example, content available via a broadcast content network that will be broadcast at a later time.

According to various embodiments, a content channel presented in a connected personalized content guide may include as much or as little content as is available and selected for presentation. For example, each channel shown in FIG. 19 includes two content items that are available for watching at the time the guide is presented. However, in some cases, one, three, or any number of content items may be available for presentation. As another example, the NBC channel shown in FIG. 19 includes only one content item available from 9:30 pm to 10:00 pm, while the Comedy channel includes a variety of movies and television shows available during that time period. As illustrated in FIG. 19, the available content may be presented in a variety of ways. When many content items are available, the content items may be presented in a tiled format, may be presented in a scrollable format, or may be presented in any other fashion.

According to various embodiments, a connected personalized content guide may include one or more customized channels. A customized channel may be provided in accordance with preferences associated with a content management account. For example, a user may tend to watch and/or rate highly movies by the director Steven Spielberg. The content management system may detect this tendency and create a customized “Steven Spielberg” channel. The customized channel may include movies directed by Steven Spielberg that are available from any of a variety of content sources. The channel may include movies that the user has not yet watched and/or movies that the user may wish to watch again. As another example, a user may tend to select programs that fall under the category of drama. The content management system may detect this tendency and create a customized “Drama” channel that includes dramatic movies, television shows, and other programs specifically selected to match the preferences and viewing history associated with the content management account.

According to various embodiments, a customized channel may be created based on any number of criteria. For example, a customized channel may be created based on the implicit or explicit preferences and viewing history associated with a content management account. As another example, a customized channel may be created based on the availability of content at the present time and/or in the future. As yet another example, a customized channel may be created based on whether content has been watched in association with the content management account. For instance, a customized channel may include content that has not yet been presented to a user and/or content that the user may wish to view again. As still another example, a customized channel may be created based on user settings or instructions. For instance, a user may specify one or more criteria or options for creating a customized channel, such as channel subject matter or whether to include content that has already been viewed.

According to various embodiments, a customized channel may be created based on the availability of content playback devices. For example, the tablet computer shown in FIG. 19 may be in companion mode with a connected television. The media system may observe that the user tends to view movies and television programs on the television, but not sports. Accordingly, the personalized content guide may include customized channels that emphasize the content that the user tends to view on the television. As another example, the tablet computer shown in FIG. 19 may be in companion mode with a desktop computer. The media system may observe that the user tends to view primarily sports-related programming on the desktop computer. Accordingly, the personalized content guide may be updated to display mainly sports-related programming.

According to various embodiments, a connected personalized content guide may include one or more standardized channels. For instance, a standardized channel may include content associated with a content source, such as the television network NBC, as shown in FIG. 19. A customized channel may be presented for any of a variety of reasons. For example, a content provider may pay to present a particular content channel to the user. As another example, a user may specifically request that the program guide include a particular standardized channel. As yet another example, a standardized channel may be presented by the media system based on an inference that the user enjoys viewing content associated with the standardized channel.

According to various embodiments, the connected personalized content guide may include options for filtering or sorting the content presented. For example, the user may filter the personalized content guide by including only content categorized as comedy. Then, instead of including a comedy channel as shown in FIG. 19, a variety of comedy-related channels may be shown. For example, the channels presented may be updated to include channels specific to different types of comedy, channels specific to various comedy shows such as Seinfeld, channels that focus on comedy movies, and other comedy-related channels. In particular embodiments, the user may sort the personalized content guide by the quality of the recommendation. Then, the personalized content guide will be updated to emphasize the most highly recommended content and/or content channels, while less recommended content is deemphasized.

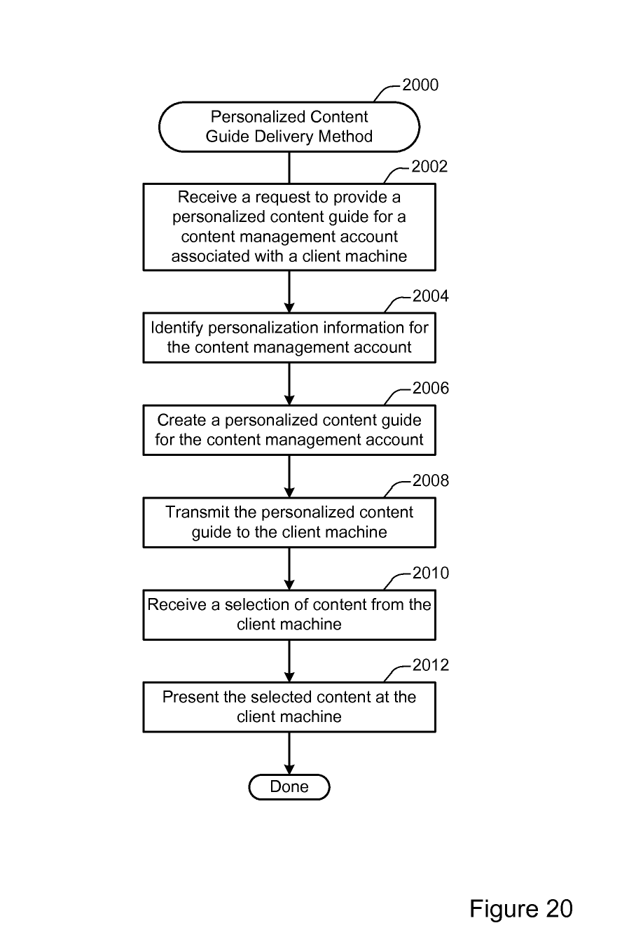

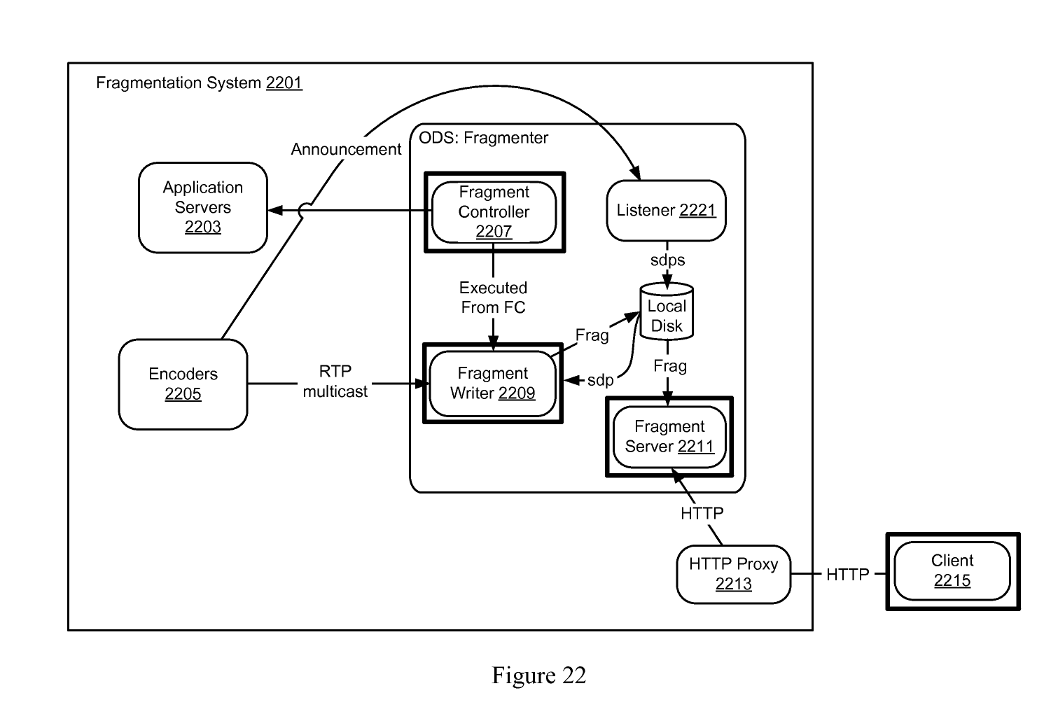

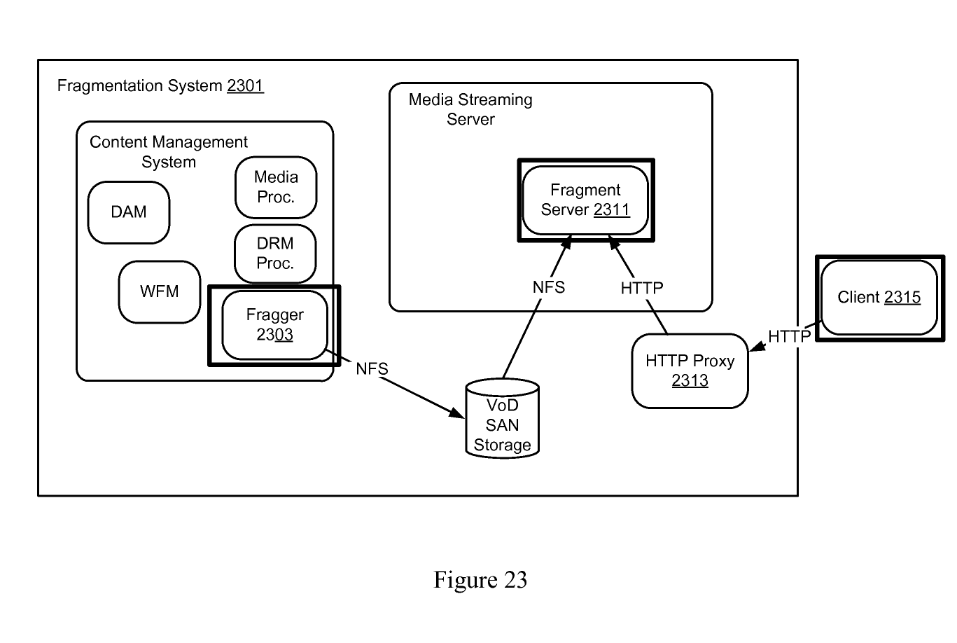

FIG. 20 illustrates a method 2000 for delivering a personalized content guide. According to various embodiments, the method 2000 may be performed at a media system in communication with a client machine. For instance, the method 2000 may be performed at a media system such as those shown in FIGS. 22 and 23. The method 2000 may be used to select content and/or content channels to include in a content guide, to transmit the content guide to the client machine, and to allow a user to select content from the content guide for presentation at the client machine or at another device.

FIG. 20 illustrates a method 2000 for delivering a personalized content guide. According to various embodiments, the method 2000 may be performed at least in part at a media system such as the systems discussed with respect to FIGS. 22 and 23. The method 2000 may be used to identify information for creating a personalized content guide, transmitting the guide to a client machine, and presenting content selected from the personalized content guide at the client machine.

At 2002, a request is received to provide a personalized content guide for a content management account associated with a client machine. According to various embodiments, the client machine may be any computing and/or content playback device capable of being used to manage or present content for presentation. In some cases, the request may be received from the device when the device is logged in to a content management account associated with the media system. In other cases, the request may be received from within the media system itself. For instance, the media system may request to create or update a personalized content guide at a designated time or upon detection of a trigger event. In this way, the personalized content guide may be at least partially prepared when the guide is requested by the client machine.

At 2004, personalization information for the content management account is identified. According to various embodiments, the personalized content guide may be created based on a variety of different factors, such as viewing history information, preference information, the devices associated with the content management account, the devices that are active during a particular period of time, and options associated with the content management account.

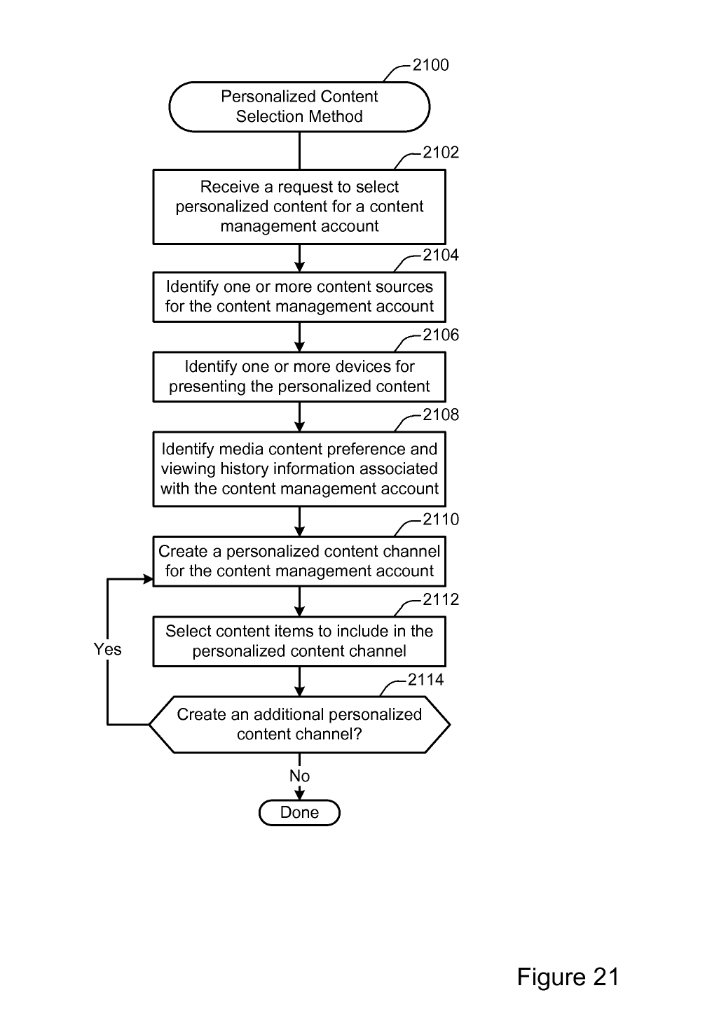

At 2006, a personalized content guide is created for the content management account. According to various embodiments, the personalized content guide may be created by creating customized content channels based on the information identified at operation 2004. Then, content items may be selected for including in the content channels to match the preferences and other information associated with the content management account. For instance, the content items and content channels may be created to match the user's expressed or estimated preferences. Techniques for creating a personalized content management are discussed in further detail with respect to FIG. 21.

At 2008, the personalized content guide is transmitted to the client machine. According to various embodiments, the personalized content guide may be transmitted to any client machine associated with the content management account. For example, the personalized content guide may be transmitted to a television having access to a network connection. As another example, the personalized content guide may be transmitted to a mobile phone configured in companion mode, companioned with another device such as a television. As yet another example, the personalized content guide may be transmitted to a mobile device operating alone, such as a tablet computer with a remote internet connection.

At 2010, a selection of content is received from the client machine. According to various embodiments, the user may select for presentation one of the items included in the personalized content guide. When the user makes a selection, a message may be transmitted from the client machine to the media server. The media server may then take steps to present the content for playback at the client machine.

At 2012, the selected content is presented to the client machine. According to various embodiments, the techniques used to transmit the content to the client machine may vary based on the type and source of the content selected. For example, if the content selected is streaming content accessed via a network service provider, then a request to transmit the streaming content may be transmitted. As another example, if the content selected is provided directly via the media system, then the content itself or instructions for receiving the selected content may be transmitted to the client machine. As yet another example, if the content selected is accessed via a network or local storage location, then an instruction to present the content for playback may be transmitted.

FIG. 21 illustrates a method 2100 of selecting personalized content. For example, the method 2100 may be used to select media content items based on a media content preferences and media viewing history associated with a content management account. As another example, the method 2100 may be used to create customized media content channels to include in a personalized content guide. According to various embodiments, the method 2100 may be performed at least in part at a media system, such as the systems discussed with respect to FIGS. 22 and 23.

At 2102, a request to select personalized content for a content management account is received. According to various embodiments, the request may be received at a media system configured to provide content management services to a potentially large number of users, content management accounts, and client machines.

According to various embodiments, the request may be generated periodically and/or upon detection of a triggering event. For example, a personalized content guide may be created and/or updated when a user logs in to the system and/or on a regular basis (e.g., every half hour) while the user remains logged in. As another example, a personalized content guide may be created when a content management account is first created, for instance on the basis of explicitly provided preferences. As yet another example, a personalized content guide may be updated periodically, such as once per day.

At 2104, one or more content sources for the content management account are identified. According to various embodiments, a media system may provide content from a variety of sources. In some systems, all content management accounts may share a common set of media sources. In other systems, different content management accounts may receive media from different media sources. For instance, each content management account may receive content from sources that may include, but are not limited to: online content services, on-demand video content services, broadcast services such as cable or satellite television, local storage locations, and networked or remote storage locations.

According to various embodiments, by identifying one or more content sources for a content management account when creating a personalized content guide, the personalized content guide may be better customized for the content management account. For instance, rather than using a different content guide or other organizational structure for each content source, a user may view the content in a single customized content guide.

At 2106, one or more devices for presenting the content are identified. According to various embodiments, content accessible via a content management account may be viewed at any of a variety of content playback devices. These devices may include, but are not limited to, laptop computers, desktop computers, tablet computers, mobile phones, televisions, and other such devices.

According to various embodiments, by identifying different devices for presenting content, the content guide may be personalized based on the device or devices on which the user would like to view content. In some cases, a user may prefer or tend to view different types of content on different devices. For instance, a user may tend to view movies on a television, sports programming on a mobile phone, and streaming television programs on a laptop computer. Accordingly, the media system may create a personalized content guide that reflects these preferences. For example, if the media system detects that a television associated with the content management account is active, then the personalized content guide may be updated to include more movies. As another example, if the media system detects that the user is accessing the personalized content guide on a mobile phone, then the personalized content guide may be updated to include more sports-related programming.

At 2108, media content preference and viewing history information associated with the content management account is identified. According to various embodiments, this information may include any information collected in association with the content management account that may allow some inference about the preferences or viewing tendencies of a user or users who use the content management account. For example, the information may include any content items previously viewed in association with the content management account as well as metadata such as when the content items were viewed, the percentage of a content item that was actually viewed, and other such information. As another example, the information may include any content items for which more information was requested. For instance, in some cases a user may select a content item to view detailed information regarding the content item such as a list of cast members, a detailed description of the content item, or a list of related content. As yet another example, the information may include any rating or preference information provided regarding content available via the content management system. For instance, a user may rate a content item as “liked” or “disliked” or may provide a rating on a different scale, such as one to five stars. As still another example, the information may include any aggregate or collected information regarding user preferences. For instance, a user may commonly view dramatic programs but may rarely view comedies.

According to various embodiments, identifying information regarding media content preference and viewing history information may allow the creation of a content guide that is personalized according to user viewing habits and preferences. For example, if a user enjoys a particular television program, a customized channel can be created that includes episodes from the television program. The customized channel may include episodes available via broadcast services at particular times, reruns accessible via streaming content services such as Netflix, and/or recently broadcast episodes available for purchase via a content service such as iTunes. As another example, if a user often selects or rates highly movies created by a particular director, a customized content channel may be created that includes movies by the director. As yet another example, if a user often views a particular genre or category of content, such as comedy or 1950's dramas, a customized channel can be created that reflects these preferences.

At 2110, a personalized content channel is created for the content management account. According to various embodiments, as discussed herein, a personalized content channel may be based on any of a variety of factors. These factors may include, but are not limited to, media content preferences, media viewing history, and an active device or devices associated with the content management account. In some cases, creating a personalized content channel may involve selecting a particular standardized content channel. For instance, a user may often select content available from the NBC television network. In this situation, the media system may select a standardized NBC channel to include in the personalized content guide associated with the content management account.

At 2112, content is selected to include in the personalized content channel. According to various embodiments, as discussed with respect to operation 2110, personalized content may be selected based on any of a variety of factors. For instance, the content items selected for inclusion in a personalized content channel may be the items that the media system estimates that the user is mostly likely to enjoy in the category associated with the personalized content channel. For example, the content channel may correspond to a category such as a particular television program. In this case, the channel may emphasize episodes that the user has not yet viewed. As another example, the content channel may correspond to a category such as dramatic programs. In this case, the content items selected may correspond to the dramas that are most similar to content items that the user has selected and/or rated highly in the past.

According to various embodiments, a personalized content channel may be created at least in part based on the preferences or viewing tendencies of similar content management accounts. For instance, a selected content management account may have a relatively limited viewing history. However, the media system may compare the viewing history of the selected account with other content management accounts to identify accounts that closely match. Then, the selected account may be provided with a personalized content channel and/or content items based at least in part on the preferences or viewing history of these matching accounts.

At 2114, a determination is made as to whether to create an additional personalized content channel. According to various embodiments, the determination may be made based on any of various factors. For example, in some instances a personalized content guide may be limited to a designated number of channels. As another example, in some instances the viewing history and/or preference information associated with a content management account may only allow for the creation of a limited number of personalized content channels.

FIG. 22 is a diagrammatic representation illustrating one example of a fragment or segment system 2201 associated with a content server that may be used in a broadcast and unicast distribution network. Encoders 2205 receive media data from satellite, content libraries, and other content sources and sends RTP multicast data to fragment writer 2209. The encoders 2205 also send session announcement protocol (SAP) announcements to SAP listener 2221. According to various embodiments, the fragment writer 2209 creates fragments for live streaming, and writes files to disk for recording. The fragment writer 2209 receives RTP multicast streams from the encoders 2205 and parses the streams to repackage the audio/video data as part of fragmented MPEG-4 files. When a new program starts, the fragment writer 2209 creates a new MPEG-4 file on fragment storage and appends fragments. In particular embodiments, the fragment writer 2209 supports live and/or DVR configurations.

The fragment server 2211 provides the caching layer with fragments for clients. The design philosophy behind the client/server application programming interface (API) minimizes round trips and reduces complexity as much as possible when it comes to delivery of the media data to the client 2215. The fragment server 2211 provides live streams and/or DVR configurations.

The fragment controller 2207 is connected to application servers 2203 and controls the fragmentation of live channel streams. The fragmentation controller 2207 optionally integrates guide data to drive the recordings for a global/network DVR. In particular embodiments, the fragment controller 2207 embeds logic around the recording to simplify the fragment writer 2209 component. According to various embodiments, the fragment controller 2207 will run on the same host as the fragment writer 2209. In particular embodiments, the fragment controller 2207 instantiates instances of the fragment writer 2209 and manages high availability.

According to various embodiments, the client 2215 uses a media component that requests fragmented MPEG-4 files, allows trick-play, and manages bandwidth adaptation. The client communicates with the application services associated with HTTP proxy 2213 to get guides and present the user with the recorded content available.

FIG. 23 illustrates one example of a fragmentation system 2301 that can be used for video-on-demand (VoD) content. Fragger 2303 takes an encoded video clip source. However, the commercial encoder does not create an output file with minimal object oriented framework (MOOF) headers and instead embeds all content headers in the movie file (MOOV). The fragger reads the input file and creates an alternate output that has been fragmented with MOOF headers, and extended with custom headers that optimize the experience and act as hints to servers.

The fragment server 2311 provides the caching layer with fragments for clients. The design philosophy behind the client/server API minimizes round trips and reduces complexity as much as possible when it comes to delivery of the media data to the client 2315. The fragment server 2311 provides VoD content.

According to various embodiments, the client 2315 uses a media component that requests fragmented MPEG-4 files, allows trick-play, and manages bandwidth adaptation. The client communicates with the application services associated with HTTP proxy 2313 to get guides and present the user with the recorded content available.

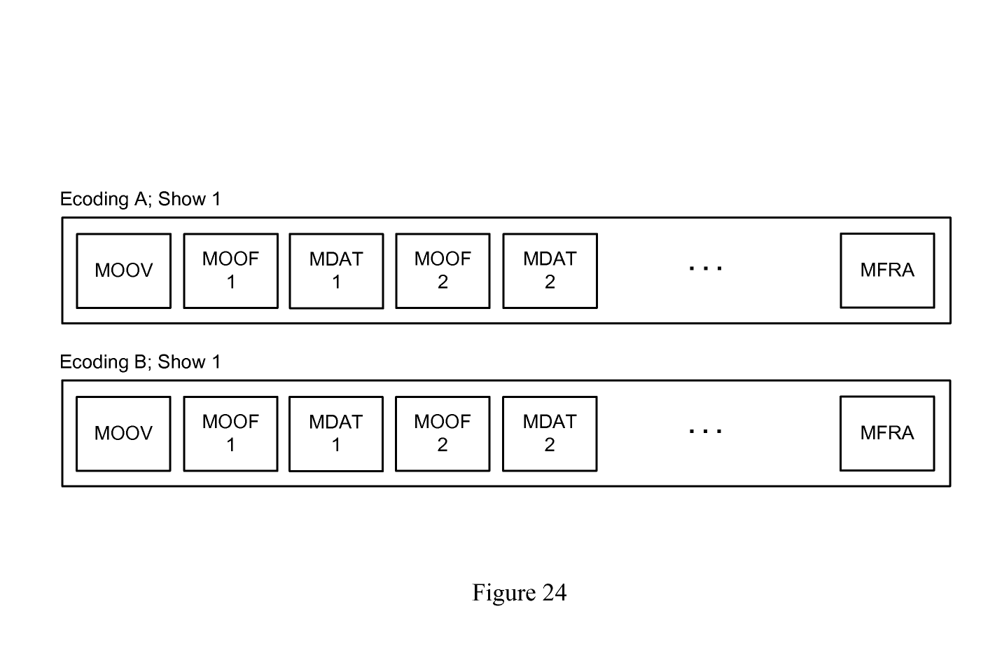

FIG. 24 illustrates examples of files stored by the fragment writer. According to various embodiments, the fragment writer is a component in the overall fragmenter. It is a binary that uses command line arguments to record a particular program based on either NTP time from the encoded stream or wallclock time. In particular embodiments, this is configurable as part of the arguments and depends on the input stream. When the fragment writer completes recording a program, it exits. For live streams, programs are artificially created to be short time intervals e.g. 5-15 minutes in length.

According to various embodiments, the fragment writer command line arguments are the SDP file of the channel to record, the start time, end time, name of the current and next output files. The fragment writer listens to RTP traffic from the live video encoders and rewrites the media data to disk as fragmented MPEG-4. According to various embodiments, media data is written as fragmented MPEG-4 as defined in MPEG-4 part 12 (ISO/IEC 14496-12). Each broadcast show is written to disk as a separate file indicated by the show ID (derived from EPG). Clients include the show ID as part of the channel name when requesting to view a prerecorded show. The fragment writer consumes each of the different encodings and stores them as a different MPEG-4 fragment.

In particular embodiments, the fragment writer writes the RTP data for a particular encoding and the show ID field to a single file. Inside that file, there is metadata information that describes the entire file (MOOV blocks). Atoms are stored as groups of MOOF/MDAT pairs to allow a show to be saved as a single file. At the end of the file there is random access information that can be used to enable a client to perform bandwidth adaptation and trick play functionality.

According to various embodiments, the fragment writer includes an option which encrypts fragments to ensure stream security during the recording process. The fragment writer will request an encoding key from the license manager. The keys used are similar to that done for DRM. The encoding format is slightly different where MOOF is encoded. The encryption occurs once so that it does not create prohibitive costs during delivery to clients.

The fragment server responds to HTTP requests for content. According to various embodiments, it provides APIs that can be used by clients to get necessary headers required to decode the video and seek any desired time frame within the fragment and APIs to watch channels live. Effectively, live channels are served from the most recently written fragments for the show on that channel. The fragment server returns the media header (necessary for initializing decoders), particular fragments, and the random access block to clients. According to various embodiments, the APIs supported allow for optimization where the metadata header information is returned to the client along with the first fragment. The fragment writer creates a series of fragments within the file. When a client requests a stream, it makes requests for each of these fragments and the fragment server reads the portion of the file pertaining to that fragment and returns it to the client.

According to various embodiments, the fragment server uses a REST API that is cache-friendly so that most requests made to the fragment server can be cached. The fragment server uses cache control headers and ETag headers to provide the proper hints to caches. This API also provides the ability to understand where a particular user stopped playing and to start play from that point (providing the capability for pause on one device and resume on another).

In particular embodiments, client requests for fragments follow the following format: http://{HOSTNAME}/frag/{CHANNEL}/{BITRATE}/[{ID}/] {COMMAND}[/{ARG}] e.g. http://frag.hosttv.com/frag/1/H8QVGAH264/1270059632.mp4/fragment/42. According to various embodiments, the channel name will be the same as the backend-channel name that is used as the channel portion of the SDP file. VoD uses a channel name of “vod”. The BITRATE should follow the BITRATE/RESOLUTION identifier scheme used for RTP streams. The ID is dynamically assigned. For live streams, this may be the UNIX timestamp; for DVR this will be a unique ID for the show; for VoD this will be the asset ID. The ID is optional and not included in LIVE command requests. The command and argument are used to indicate the exact command desired and any arguments. For example, to request chunk 42, this portion would be “fragment/42”.

The URL format makes the requests content delivery network (CDN) friendly because the fragments will never change after this point so two separate clients watching the same stream can be serviced using a cache. In particular, the head end architecture leverages this to avoid too many dynamic requests arriving at the Fragment Server by using an HTTP proxy at the head end to cache requests.

According to various embodiments, the fragment controller is a daemon that runs on the fragmenter and manages the fragment writer processes. A configured filter that is executed by the fragment controller can be used to generate the list of broadcasts to be recorded. This filter integrates with external components such as a guide server to determine which shows to record and which broadcast ID to use.

According to various embodiments, the client includes an application logic component and a media rendering component. The application logic component presents the user interface (UI) for the user, communicates to the front-end server to get shows that are available for the user, and authenticates the content. As part of this process, the server returns URLs to media assets that are passed to the media rendering component.

In particular embodiments, the client relies on the fact that each fragment in a fragmented MP4 file has a sequence number. Using this knowledge and a well-defined URL structure for communicating with the server, the client requests fragments individually as if it was reading separate files from the server simply by requesting URLs for files associated with increasing sequence numbers. In some embodiments, the client can request files corresponding to higher or lower bit rate streams depending on device and network resources.

Since each file contains the information needed to create the URL for the next file, no special playlist files are needed, and all actions (startup, channel change, seeking) can be performed with a single HTTP request. After each fragment is downloaded, the client assesses, among other things, the size of the fragment and the time needed to download it in order to determine if downshifting is needed or if there is enough bandwidth available to request a higher bit rate.

Because each request to the server looks like a request to a separate file, the response to requests can be cached in any HTTP Proxy, or be distributed over any HTTP based content delivery network CDN.

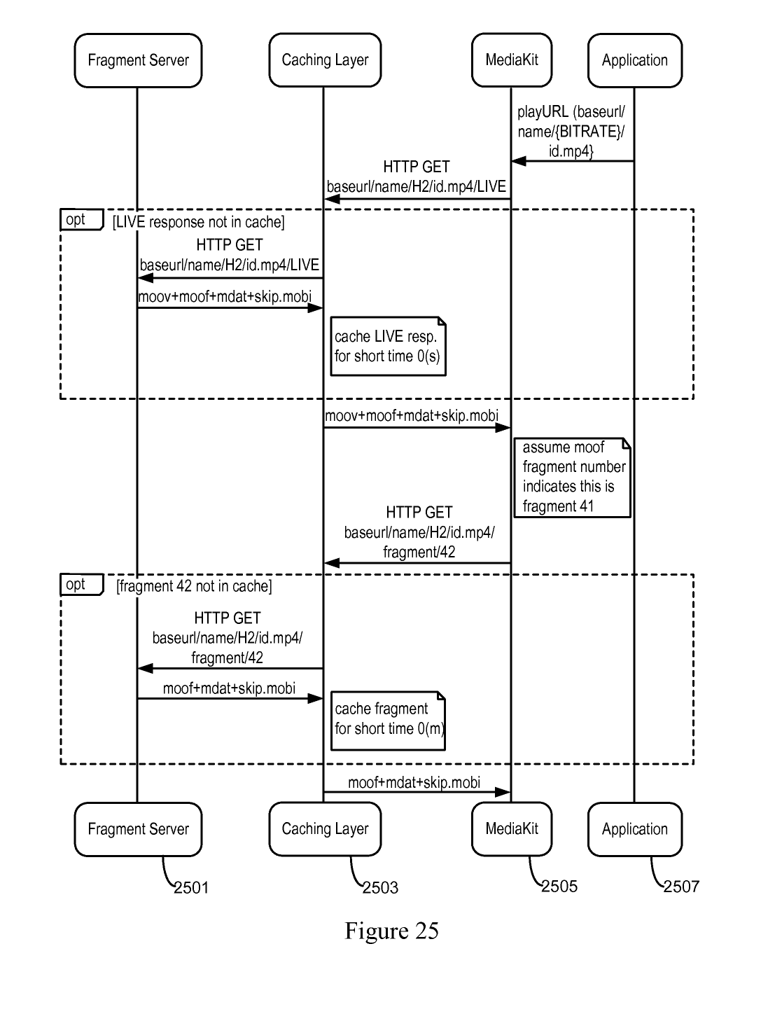

FIG. 25 illustrates an interaction for a client receiving a media stream such as a live stream. The client starts playback when fragment 41 plays out from the server. The client uses the fragment number so that it can request the appropriate subsequent file fragment. An application such as a player application 2507 sends a request to mediakit 2505. The request may include a base address and bit rate. The mediakit 2505 sends an HTTP get request to caching layer 2503. According to various embodiments, the live response is not in cache, and the caching layer 2503 forwards the HTTP get request to a fragment server 2501. The fragment server 2501 performs processing and sends the appropriate fragment to the caching layer 2503 which forwards to the data to mediakit 2505.

The fragment may be cached for a short period of time at caching layer 2503. The mediakit 2505 identifies the fragment number and determines whether resources are sufficient to play the fragment. In some examples, resources such as processing or bandwidth resources are insufficient. The fragment may not have been received quickly enough, or the device may be having trouble decoding the fragment with sufficient speed. Consequently, the mediakit 2505 may request a next fragment having a different data rate. In some instances, the mediakit 2505 may request a next fragment having a higher data rate. According to various embodiments, the fragment server 2501 maintains fragments for different quality of service streams with timing synchronization information to allow for timing accurate playback.

The mediakit 2505 requests a next fragment using information from the received fragment. According to various embodiments, the next fragment for the media stream may be maintained on a different server, may have a different bit rate, or may require different authorization. Caching layer 2503 determines that the next fragment is not in cache and forwards the request to fragment server 2501. The fragment server 2501 sends the fragment to caching layer 2503 and the fragment is cached for a short period of time. The fragment is then sent to mediakit 2505.

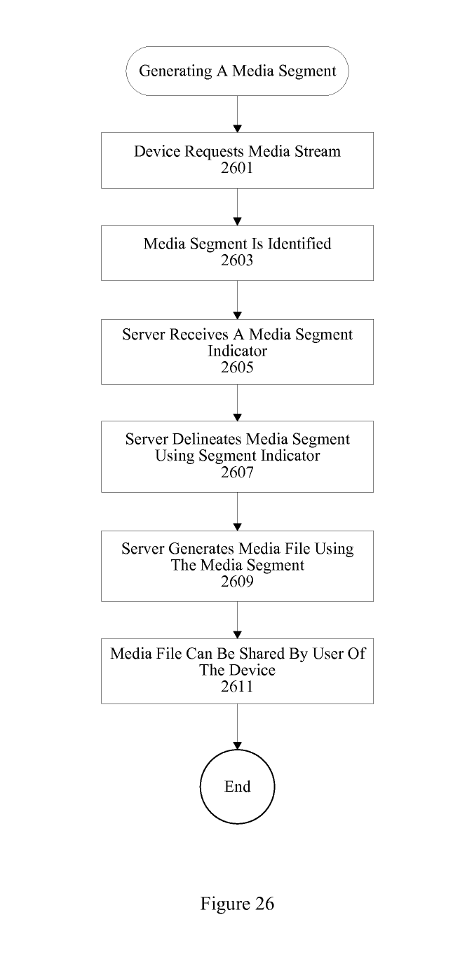

FIG. 26 illustrates a particular example of a technique for generating a media segment. According to various embodiments, a media stream is requested by a device at 2601. The media stream may be a live stream, media clip, media file, etc. The request for the media stream may be an HTTP GET request with a baseurl, bit rate, and file name. At 2603, the media segment is identified. According to various embodiments, the media segment may be a 35 second sequence from an hour long live media stream. The media segment may be identified using time indicators such as a start time and end time indicator. Alternatively, certain sequences may include tags such as fight scene, car chase, love scene, monologue, etc., that the user may select in order to identify a media segment. In still other examples, the media stream may include markers that the user can select. At 2605, a server receives a media segment indicator such as one or more time indicators, tags, or markers. In particular embodiments, the server is a snapshot server, content server, and/or fragment server. According to various embodiments, the server delineates the media segment maintained in cache using the segment indicator at 2607. The media stream may only be available in a channel buffer. At 2609, the server generates a media file using the media segment maintained in cache. The media file can then be shared by a user of the device at 2611. In some examples, the media file itself is shared while in other examples, a link to the media file is shared.

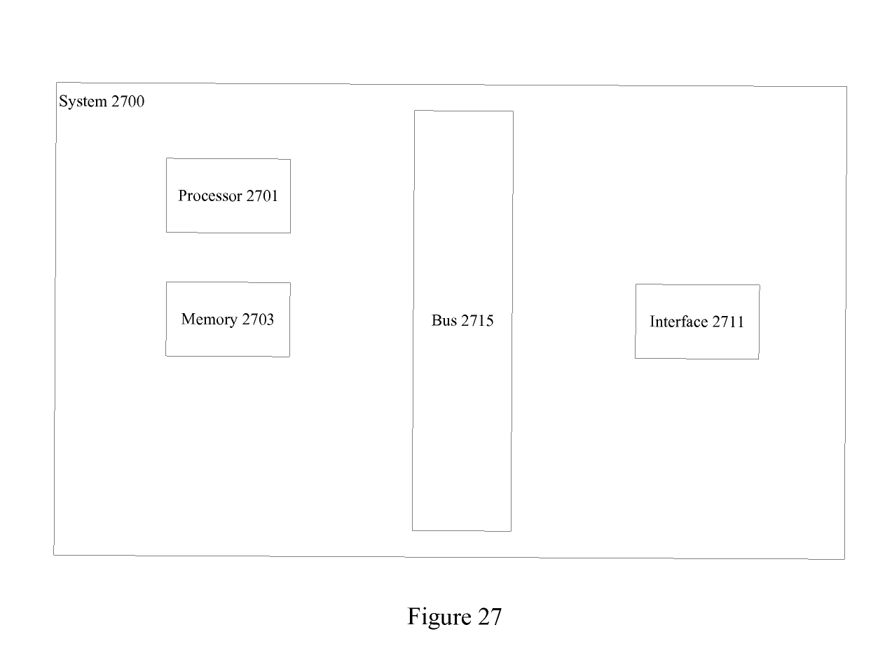

FIG. 27 illustrates one example of a server. According to particular embodiments, a system 2700 suitable for implementing particular embodiments of the present invention includes a processor 2701, a memory 2703, an interface 2711, and a bus 2715 (e.g., a PCI bus or other interconnection fabric) and operates as a streaming server. When acting under the control of appropriate software or firmware, the processor 2701 is responsible for modifying and transmitting live media data to a client. Various specially configured devices can also be used in place of a processor 2701 or in addition to processor 2701. The interface 2711 is typically configured to send and receive data packets or data segments over a network.

Particular examples of interfaces supported include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control communications-intensive tasks such as packet switching, media control and management.

According to various embodiments, the system 2700 is a server that also includes a transceiver, streaming buffers, and a program guide database. The server may also be associated with subscription management, logging and report generation, and monitoring capabilities. In particular embodiments, the server can be associated with functionality for allowing operation with mobile devices such as cellular phones operating in a particular cellular network and providing subscription management capabilities. According to various embodiments, an authentication module verifies the identity of devices including mobile devices. A logging and report generation module tracks mobile device requests and associated responses. A monitor system allows an administrator to view usage patterns and system availability. According to various embodiments, the server handles requests and responses for media content related transactions while a separate streaming server provides the actual media streams.

Although a particular server is described, it should be recognized that a variety of alternative configurations are possible. For example, some modules such as a report and logging module and a monitor may not be needed on every server. Alternatively, the modules may be implemented on another device connected to the server. In another example, the server may not include an interface to an abstract buy engine and may in fact include the abstract buy engine itself. A variety of configurations are possible.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

1. A method comprising:
transmitting a personalized content guide to a first client machine, the first client machine being associated with a content management account, the personalized content guide including a plurality of media content channels created based on media content viewing history information associated with the content management account, each of the media content channels including a respective plurality of media content items available for presentation in association with the content management account;
receiving, from the first client machine, a message indicating a selection of one of the media content items; and
transmitting, to a second client machine, an instruction for presenting the selected media content item at the second client machine.

2. The method recited in claim 1, wherein the selected media content item is capable of being presented at a plurality of client machines including the second client machine, and wherein the message received from the client machine also indicates a selection of the second client machine for presenting the media content item.

3. The method recited in claim 1, wherein the media content viewing history information includes a plurality of preferences regarding content items expressed in association with the content management account.

4. The method recited in claim 1, wherein the respective plurality of media content items included in each of the media content items is selected based on the media content viewing history information.

5. The method recited in claim 1, wherein the media content viewing history information includes information identifying a tendency for media content items associated with a designated category to be selected for presentation at the second client machine.

6. The method recited in claim 1, wherein each of the media content items is available from a respective media content source, and wherein at least two of the media content items are retrievable from different media content sources.

7. The method recited in claim 1, wherein at least one of the media content sources is a media content service provider in communication with the second client machine via a network.

8. The method recited in claim 1, wherein one or more of the media content items includes a video stream capable of being accessed via a network.

9. A system comprising:
a storage module operable to store content viewing history information associated with a content management account,
a processor operable to create a personalized content guide associated with the content management account, the personalized content guide including a plurality of media content channels created based on media content viewing history information associated with the content management account, each of the media content channels including a respective plurality of media content items available for presentation in association with the content management account; and
a network interface operable to:
transmit the personalized content guide to a first client machine associated with the content management account,
receive from the first client machine a message indicating a selection of one of the media content items, and
transmit to a second client machine an instruction for presenting the selected media content item at the second client machine.

10. The system recited in claim 9, wherein the selected media content item is capable of being presented at a plurality of client machines including the second client machine, and wherein the message received from the client machine also indicates a selection of the second client machine for presenting the media content item.

11. The system recited in claim 9, wherein the media content viewing history information includes a plurality of preferences regarding content items expressed in association with the content management account.

12. The system recited in claim 9, wherein the respective plurality of media content items included in each of the media content items is selected based on the media content viewing history information.

13. The system recited in claim 9, wherein the media content viewing history information includes information identifying a tendency for media content items associated with a designated category to be selected for presentation at the second client machine.

14. The system recited in claim 9, wherein each of the media content items is available from a respective media content source, and wherein at least two of the media content items are retrievable from different media content sources.

15. The system recited in claim 9, wherein each of the media content items is available from a respective media content source, and wherein at least two of the media content items are retrievable from different media content sources.

16. One or more computer readable media having instructions stored thereon for performing a method, the method comprising:
transmitting a personalized content guide to a first client machine, the first client machine being associated with a content management account, the personalized content guide including a plurality of media content channels created based on media content viewing history information associated with the content management account, each of the media content channels including a respective plurality of media content items available for presentation in association with the content management account;
receiving, from the first client machine, a message indicating a selection of one of the media content items; and
transmitting, to a second client machine, an instruction for presenting the selected media content item at the second client machine.

17. The one or more computer readable media recited in claim 16, wherein the selected media content item is capable of being presented at a plurality of client machines including the second client machine, and wherein the message received from the client machine also indicates a selection of the second client machine for presenting the media content item.

18. The one or more computer readable media recited in claim 16, wherein the media content viewing history information includes a plurality of preferences regarding content items expressed in association with the content management account.

19. The one or more computer readable media recited in claim 16, wherein the respective plurality of media content items included in each of the media content items is selected based on the media content viewing history information.

20. The one or more computer readable media recited in claim 16, wherein the media content viewing history information includes information identifying a tendency for media content items associated with a designated category to be selected for presentation at the second client machine.
